(19) United States
(12) Patent Application Publication
(10) Pub. No.: US 2004/0046128 A1
(43) Pub. Date: Mar. 11, 2004

(54) Sensor platform and method for the determination of multiple analytes

(76) Inventors: Andreas Peter Abel, Basel (CH); Gert Ludwig Duveneck, Bad Krozingen (DE); Markus Ehrat, Magden (CH); Gerhard Matthias Kresbach, Staufen (DE)

Correspondence Address: WENDEROTH, LIND & PONACK, L.L.P., 2033 K STREET N. W., SUITE 800, WASHINGTON, DC, 20006-1021, US

(21) Appl. No.: 10/649,677

(22) Filed: Aug. 28, 2003

Related U.S. Application Data
(63) Continuation of application No. 10/000,957, filed on Dec. 4, 2001, now abandoned.
Application No. 10/000,957 is a continuation of application No. PCT/EP00/04869, filed on May 29, 2000.

(30) Foreign Application Priority Data
Jun. 5, 1999 (CH) 1047/99
Apr. 6, 2000 (CH) 689/00

(51) Int. Cl. G01N 21/64

(52) U.S. Cl. 250/458.1

(57) ABSTRACT

A sensor platform, based on a planar optical thin-film waveguide is used to determine one or more luminescences from one or more measurement areas on the sensor platform. The sensor platform has a first optically transparent layer on a second optically transparent layer of lower refractive index than the first optically transparent layer, and at least one grating structure to incouple excitation light to the measurement areas or to outcouple luminescence light from the measurement areas. An optical system is also used for luminescence determination. Further, an analytical system having the sensor platform, the optical system, and a supply device to bring one or more samples in contact with the measurement areas on the sensor platform is used for luminescence determination.

This application is a continuation of Ser. No. 10,000,957, filed Dec. 4, 2001, which is a continuation of International Application Ser. No. PCT/EP/00/04869, filed May 29, 2000.

### BACKGROUND OF THE INVENTION

1. Field of the Invention

The invention is related to a variable embodiment of a sensor platform based on a planar thin-film waveguide for the determination of one or more luminescences from one or more measurement areas on the sensor platform.

Objectives of this invention are to provide sensor platforms, as well as optical and analytical measurement arrangements for a highly sensitive determination of one or more analytes.

2. Description of the Related Art

When a light wave is coupled into a planar thin-film waveguide surrounded by media of lower refractive index, the light wave is guided by total reflection at interfaces of the waveguiding layer. In the simplest case, a planar thin-film waveguide consists of a three-layer system of a support material (substrate), a waveguiding layer, and a superstrate (respectively, the sample to be analyzed), wherein the waveguiding layer has the highest refractive index. Additional intermediate layers can further improve the action of the planar waveguide.

In this arrangement, a fraction of the electromagnetic energy penetrates the media of lower refractive index. This portion of the electromagnetic energy is termed the evanescent (decaying) field. The strength of the evanescent field depends to a very great extent on the thickness of the waveguiding layer itself and on the ratio of the refractive indices of the waveguiding layer and of the media surrounding it. In the case of thin waveguides, i.e., layer thicknesses that are the same as or smaller than the wavelength of the light to be guided, discrete modes of the guided light can be distinguished.

Several methods for the incoupling of excitation light into a planar waveguide are known. The earliest methods used were based on front face coupling or prism coupling, wherein generally, a liquid is introduced between the prism and the waveguide, in order to reduce reflections due to air gaps. These two methods are mainly suited with respect to waveguides of relatively large layer thickness, i.e., especially self-supporting waveguides, and with respect to waveguides with a refractive index significantly below 2. For incoupling of excitation light into very thin waveguiding layers of high refractive index, however, the use of coupling gratings is a significantly more elegant method.

Different methods of analyte determination in the evanescent field of lightwaves guided in optical film (stratified) waveguides can be distinguished. Based on the applied measurement principle, for example, it can be distinguished between fluorescence, or more general luminescence methods, on one side and refractive methods on the other side. In this context, methods for generation of surface plasmon renonance in a thin metal layer on a dielectric layer of lower refractive index can be included in the group of refractive methods, if the resonance angle of the launched excitation light for generation of the surface plasmon resonance is taken as the quantity to be measured. Surface plasmon resonance can also be used for the amplification of a luminescence or the improvement of the signal-to-background ratios in a luminescence measurement. The conditions for generation of a surface plasmon resonance and the combination with luminescence measurements, as well as with waveguiding structures, are described in the literature, for example in U.S. Pat. Nos. 5,478,755, 5,841,143, 5,006,716, and U.S. Pat. No. 4,649,280.

In this application, the term “luminescence” means the spontaneous emission of photons in the range from ultraviolet to infrared, after optical or other than optical excitation, such as electrical or chemical or biochemical or thermal excitation.

For example, chemiluminescence, bioluminescence, electroluminescence, and especially fluorescence and phosphorescence are included under the term “luminescence”.

In cases of the refractive measurement methods, the change of the effective refractive index resulting from molecular adsorption to or desorption from the waveguide is used for analyte detection. This change of the effective refractive index is determined, in the case of grating coupler sensors, from changes of the coupling angle for the in- or outcoupling of light into or out of the grating coupler sensor, and in the case of interferometric sensors from changes of the phase difference between measurement light guided in a sensing branch and a referencing branch of the interferometer.

The state of the art for using one or more coupling gratings for the in- and/or outcoupling of guided waves (by means of one or more coupling gratings) is described, for example, in K. Tiefenthaler, W. Lukosz, “Sensitivity of grating couplers as integrated-optical chemical sensors”, J. Opt. Soc. Am. B6, 209 (1989); W. Lukosz, Ph. M. Nellen, Ch. Stamm, P. Weiss, “Output Grating Couplers on Planar Waveguides as Integrated, Optical Chemical Sensors”, Sensors and Actuators B1, 585 (1990); and in T. Tamir, S. T. Peng, “Analysis and Design of Grating Couplers”, Appl. Phys. 14, 235-254 (1977).

The aforesaid refractive methods have an advantage that they can be applied without using additional marker molecules, so-called molecular labels. The disadvantage of these label-free methods, however, is that the achievable detection limits are limited to pico- to nanomolar concentration ranges, dependent on the molecular weight of the analyte, due to lower selectivity of the measurement principle, which is not sufficient for many applications of modem trace analysis, for example, for diagnostic applications.

For achieving lower detection limits, luminescence-based methods appear more suitable, because of higher selectivity of signal generation. In this arrangement, luminescence excitation is limited to the penetration depth of the evanescent field into the medium of lower refractive index, i.e., to immediate proximity of the waveguiding area, with a penetration depth of the order of some hundred nanometers into the medium. This principle is called evanescent luminescence excitation. For analytics, evanescent luminescence excitation is of great interest, as the excitation is restricted to the immediate vicinity of the waveguiding layer and disturbing effects from the depth of the bulk medium can be minimized.

Photometric instruments for determining the luminescence of biosensors under conditions of evanescent excitation using planar optical waveguides are likewise known and are described, for example, in WO 90/06503. The waveguiding layers used in that specification are from 160 nm to 1000 nm thick, and the excitation wave is coupled in without grating couplers.

Various attempts have been made to increase the sensitivity of evanescently excited luminescence and to manufacture integrated optical sensors. For example, a report in Biosensors & Bioelectronics 6 (1991), 595-607, describes planar monomodal or low-modal waveguides that are produced in a two-step ion-exchange process, wherein the excitation wave is incoupled using prisms. The affinity system used is human immunoglobulin G/fluorescein-labeled protein A, the antibody being immobilized on the waveguide and the fluorescein-labeled protein A to be detected being added in a phosphate buffer to a film of polyvinyl alcohol, with which the measuring region of the waveguide is covered.

A considerable disadvantage of that method is that only small differences in refractive index between the waveguiding layer and the substrate layer can be achieved, with the result that the sensitivity is relatively low. The sensitivity is given as 20 nM of fluorescein-labeled protein A. That is still not satisfactory for the determination of very small traces and a further increase in sensitivity is therefore required. In addition, the incoupling of light using prisms is difficult to reproduce and to carry out in practice owing to the great extent to which the incoupling efficiency is dependent on the quality and size of the contact surface between the prism and the waveguide.

In U.S. Pat. No. 5,081,012 a different principle is proposed. The planar waveguiding layer is from 200 nm to 1000 nm thick and contains two gratings, one of which is in the form of a reflection grating, with the result that the incoupled lightwave has to pass at least twice through the sensor region between the gratings. This is supposed to produce increased sensitivity. A disadvantage is that the reflected radiation can lead to an undesirable increase in background radiation intensity.

WO 91/10122 describes a thin-layered spectroscopic sensor which comprises an incoupling grating and a physically remote outcoupling grating. It is suitable, especially for absorption measurement, if an inorganic metal oxide of high refractive index is used as the waveguiding layer. Various embodiments that are suitable for the incoupling and outcoupling of multi-chromatic light sources are described. The preferred thickness of the waveguiding layer is greater than 200 nm and the grating depth should be approx. 100 nm. Those conditions are not suitable for luminescence measurements in affinity sensing, since only low sensitivity is obtained. This is confirmed in Appl. Optics Vol. 29, No. 31 (1990), 4583-4589 by the data for the overall efficiency of those systems: 0.3%at633 nm and 0.01% at 514 nm.

In another embodiment of the same sensor, a plurality of polymeric planar waveguiding layers that can be used as a gas-mixture analyzer are applied to a substrate. Use is made in that case of the change in the effective refractive index or the change in the layer thickness of the polymer waveguide upon contact with, for example, solvent vapors. The waveguiding structure is physically altered thereby. However, such changes are totally unsuitable for luminescence measurements in affinity sensing, since the incoupling is altered, increasing scatter occurs, and there can be a significant decrease in sensitivity.

Other arrangements are known, wherein a luminescence amplification is supposed to occur without a direct incoupling of excitation light, but mediated by near-field effects upon excitation of luminescent molecules at or near to (i.e., in a distance of up to some hundred nanometers) the surface of a waveguide. For example, in U.S. Pat. No. 4,649,280 a multilayer system with a conductive and reflective material (for example silver) on a substrate, a dielectric optical waveguide (for example of lithium fluoride with refractive index of only 1.39) and a film of molecules capable of fluoresce deposited thereon, is described. In a further development, in U.S. Pat. No. 5,006,716, it is additionally proposed to produce the conductive film in the form of a surface relief grating, which form is reproduced in the course of the deposition process for manufacture of the final structure up to the surface. It is described as an advantage of this arrangement, that luminescence light coupled into the waveguiding layer could be outcoupled by the grating into discrete spatial directions, corresponding to the outcoupled diffraction orders and the modes guided in the waveguide, thus allowing for collecting a larger fraction of the luminescence by a detector, if it were positioned in the direction of the outcoupled luminescence light. An essential part of these arrangements with a waveguiding layer of relatively low refractive index, however, is the existence of a reflecting metal layer located underneath.

For a reproducible production, however, a simpler two-layer system, like a thin-film waveguide, appears to be better suited. It is also highly desirable to use a waveguiding film with a refractive index as high as possible, in order to increase the intensity of the evanescent field.

By means of higly refractive thin-film waveguides, based on only some hundred nanometers thin waveguiding film on a transparent support material, the sensitivity has been increased considerably during the last few years. In WO 95/33197, for example, a method is described, wherein the excitation light is coupled into the waveguiding film by a relief grating as a diffractive optical element. The surface of the sensor platform is contacted with a sample containing the analyte, and the isotropically emitted luminescence from substances capable of luminescence, that are located within the penetration depth of the evanescent field, is measured by adequate measurement arrangements, such as photodiodes, photomultipliers or CCD cameras. The portion of evanescently excited radiation that has backcoupled into the waveguide, can also be outcoupled by a diffractive optical element, like a grating, and be measured. This method is described, for example, in WO 95/33198.

A disadvantage of all methods for the detection of evanescently excited luminescence described as the state of the art, especially in the specifications WO 95/33197 and WO 95/33198, is that in all cases only one sample can be analyzed on the waveguiding layer of the sensor platform, which layer is formed as a homogeneous film. In order to perform further measurements on the same sensor platform, tedious washing or cleaning steps are continuously required. This holds especially true, if an analyte different from the one in the first measurement has to be determined. In case of an immunoassay this means, in general, that the whole immobilized layer on the sensor platform has to be exchanged, or that even a whole new sensor platform has to be used.

Therefore, there is a need for the development of a method that allows for analyzing multiple samples in parallel, i.e., simultaneously or immediately one after the other without additional cleaning steps.

For example, in WO 95/03538, it is proposed to provide multiple sample cells above a continuous waveguiding layer, which are formed as recesses in a base plate above the waveguiding layer. Underneath each sample cell is located a grating that outcouples a part of the light guided in the waveguiding layer. The determination of the analyte is based on the change of the outcoupling angle as a function of the analyte concentration. In general, this method, which is based on the change of the refractive index, is considerably less sensitive than luminescence methods.

WO 94/27137 proposes, for example, an apparatus and a method for carrying out immunoassays using evanescently excited fluorescence. The apparatus consists of a continuous optical waveguide having two plane-parallel surfaces and a lateral edge that acts in conjunction with a lens as incoupling element. A plurality of specific binding partners are immobilized on at least one surface. In a preferred embodiment, those specific binding partners are arranged on the continuous waveguide so that they are physically separate from one another. In the working Example they are distributed in the form of dots over the surface of the waveguide.

On the basis of the embodiments disclosed, it must be assumed that the efficiency achieved by incoupling via the lateral edge is lower than in the case of incoupling via gratings. Furthermore, owing to the large layer thickness (self-supporting waveguide), the strength of the evanescent field and hence, the excitation efficiency, is considerably lower than in the case of monomodal waveguides of relatively small layer thickness. Overall, the sensitivity of the arrangement is limited as a result.

Those arrangements in which various specific binding partners are applied to a continuous waveguiding layer also have the disadvantage that the excitation light excites all of the fluorophore-labeled molecules. Selection of measurement sites according to location is thus not possible. In addition, evanescently backcoupled fluorescence photons may contribute to the signal from the neighboring dot and thus lead to measurement errors.

In integrated optics for applications in telecommunications, glass-based planar optical components are known that contain waveguides in the form of channels, the waveguiding channels being produced by the exchange of individual ions at the surface with the aid of masks (Glastechnische Berichte Vol. 62, page 285, 1989). A physically interconnected layer exhibits a slight increase in refractive index in the channels that have been doped with ions. The increase is generally less than 5%. Such components are complicated and expensive to produce.

In SPIE Vol. 1587 Chemical, Biochemical and Environmental Fiber Sensors III (1991), pages 98-113, R. E. Kunz describes optical waveguides that fork and then come together again and that are suitable especially for integrated optical instruments, such as interferometers. Such structures are not suitable for evanescently excited luminescence measurement, since the elements cannot be addressed individually, and since the arrangement of a plurality of forks one after the other rapidly leads to large intensity losses for the lightwave coupled-in at the first fork. Since the opening angle of such forks is small (typically 3°), the distances between the two branches of a fork in the case of small components are short or else the dimensions of the components have to be made correspondingly larger, which is generally undesirable. In addition, the fixed phase relationship between the forked waves is not required for luminescence measurements.

In WO 99/13320, an optical sensor for the detection of at least two different light portions is claimed. This specification mainly refers to refractive measurement methods. However, fluorescence and phosphorescence methods for generation of the measurement signal are claimed additionally. In the specification WO 99/13320, which also refers to determinations of multiple analytes, several different definitions of the generation of multiple “sensing pads”, also on the same physical region (grating waveguide structure according to the nomenclature in WO 99/13320) of the claimed sensor, are given. However, there is no hint at an arrangement of multiple measurement areas, according to the following definition in our specification, on a continuously modulated grating structure according to another following definition in our specification. Furthermore, there is also no hint of how a disturbing cross-talk between measurement light from adjacent measurement areas, especially of luminescence backcoupled into the waveguiding layer, could be prevented in case of a high density of measurement areas on the sensor platform.

A solution to this problem is of utmost importance, in order to achieve a miniaturization of the sensor platform as far as possible, for providing a maximum number of different measurement areas on a common platform.

For example in the specification WO 96/35940, arrangements (arrays) have been proposed, wherein at least two discrete waveguiding areas, to which excitation light is launched separately, are provided on one sensor platform in order to perform exclusively luminescence-based, multiple measurements with essentially monomodal, planar inorganic waveguides either simultaneously or sequentially. A drawback resulting from the partitioning of the sensor platform into discrete waveguiding areas, however, is the relatively large need of space for discrete measurement areas in discrete waveguiding regions on the common sensor platform, because of which, again, only a relatively low density of different measurement areas (or so-called “features”) can be achieved.

Therefore, there is a need for an increase of the feature density, or for a reduction of the required space per measurement area.

Based on simple glass or microscope slides, without additional waveguiding layers, arrays with a very high feature density are known. For example, in U.S. Pat. No. 5,445,934 (Affymax Technologies), arrays of oligonucleotides with a density of more than 1000 features on a square centimeter are described and claimed. The excitation and read-out of such arrays is based on classical optical arrangements and methods. The whole array can be illuminated simultaneously, using an expanded excitation light bundle, which, however, results in a relatively low sensitivity, the portion of scattered light being relatively large and scattered light or background fluorescence light from the glass substrate also being generated in those regions where no oligonucleotides for binding of the analyte are immobilized. In order to limit excitation and detection to the regions of immobilized features and to suppress light generation in the adjacent regions, there is widespread use of confocal measurement arrangements, and the different features are analyzed sequentially by scanning. The consequences, however, are an increased amount of time for the read-out of a large array and a relatively complex optical set-up.

Therefore, there is a need for an embodiment of the sensor platform and for an optical arrangement that allow for achieving a sensitivity as high as it has been achieved with sensor platforms based on thin-film waveguides and for minimizing simultaneously the required measurement area per feature.

### SUMMARY OF THE INVENTION

The sensor platform of the present invention comprises an optical film waveguide of different layers (“stratified waveguide”) with a first optically transparent layer (a) on a second optically transparent layer (b) of lower refractive index than layer (a) and at least one grating structure for the incoupling of excitation light to the measurement areas. The invention is also related to an optical system for luminescence determination. The optical system comprises an excitation light source, an embodiment of the sensor platform according to the invention, and at least one detector for the collection of the light emanating from the measurement areas on the sensor platform. The invention is also related to an analytical system that comprises a sensor platform according to the invention, an optical system according to the invention, and supply means for contacting one or more samples with the measurement areas on the sensor platform. Further subjects of the invention are methods for making determinations by luminescence detection based on sensor platforms, optical systems and analytical systems according to the invention and the use of these methods for quantitative affinity sensing and for some further, different applications.

### BRIEF DESCRIPTION OF THE DRAWINGS

FIG. 1 shows total luminescence signals along a row of measurement areas located on a grating structure I of a sensor platform according to the present invention (Example 1(a)), with a grating depth of (12+/−) 3 nm. With these parameters, an efficiency of in- and outcoupling of excitation light is incomplete, resulting in a positive gradient of an intensity of available excitation light, in a direction of a guided mode (propagating from left to right).

FIG. 2 shows total luminescence signals along a row of measurement areas of a segment of measurement areas located between grating structures I and II of a sensor platform according to the present invention (Example 1(a)). The propagation losses in an optically transparent layer (a) between the two grating structures, corresponding to a negative gradient of an intensity of available guided excitation light, lead to a decrease of luminescence signals with increasing propagation length to the guided excitation light.

FIG. 3 shows total luminescence signals along a row of measurement areas located on a grating structure I of a sensor platform according to the present invention (Example 1(a)), with a grating depth of (12+/−) 3 nm. With these parameters, an efficiency of in- and outcoupling of the excitation light is incomplete, resulting in a positive gradient of the intensity of available excitation light, in a direction of a guided mode (propagating from right to left).

FIG. 4 shows total luminescence signals along a row of measurement areas located on a continuous grating structure of a sensor platform according to the present invention (Example 1(b)), with a grating depth of (25+/−) 5 nm. These parameters lead to a very small positive gradient of an intensity of available excitation light, in a direction of a guided mode (propagating from left to right left), which hardly exceeds a statistical variation of measurement results.

FIG. 5a shows schematically a perspective view of a grating waveguide structure with a surface relief grating structure (c) modulated continuously in one of the surfaces of the second optically transparent layer (b) (see enlargement) and extending over the major part of the structure. The grating structure is transferred into the surface of the first optically transparent layer (a) upon its deposition on layer (b).

FIG. 5b shows schematically a cross-sectional view of a sensor platform according to the invention. A grating structure (c) is continuously modulated in the region of the depicted measurement areas (d). The grating structure has been first generated in the surface of the second optically transparent layer (b) and has been transferred into the further layers upon their depositions. In this example, an additional, intermediate layer (b′) has been first deposited on layer (b), before the deposition of the first optically transparent layer (a) with the highest refractive index. On top of layer (a), an adhesion-promoting layer (f) is indicated, on which laterally separated measurement areas (d) are generated by laterally selective deposition of biological or biochemical or synthetic recognition elements. Several measurement areas (d) can be combined to segments (d′) of measurement areas. Also indicated is walls (g) of a sample compartment, which can be provided if a body of adequate shape (recesses towards the sensor platform) is combined with the sensor platform as a baseplate.

FIGS. 6a and b show schematically, an example of a superposition of two surface relief grating structures of different periodicities and of different grating depths.

FIGS. 7a and b show schematically, an example of a structure with a phase or volume grating, with a periodic modulation in the essentially planar, optically transparent layer (a). Dependent on the process of generation of the refractive index modulation in layer (a), this modulation can extend to a different degree into the depth of layer (a) (in direction of layer (b)).

### DETAILED DESCRIPTION OF THE INVENTION

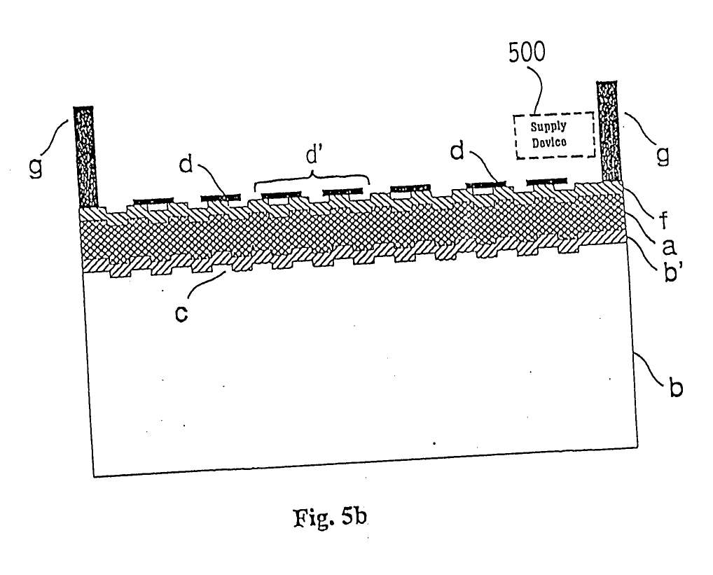

As illustrated in different embodiments illustrated in FIGS. 5(a) to 7(b), it now has been found that the luminescence light coupled back into a waveguiding layer (a) of a sensor platform, into which excitation light had been incoupled by a grating structure (c), can be outcoupled completely within short distances, i.e., within some hundred micrometers, by a grating structure (c′), and that further propagation of this luminescence light in the waveguiding layer (a) can thus be prevented, if the right parameters, especially for the grating depth, are chosen for the grating structure (c′) adjacent to a measurement area (d) on a sensor platform with a waveguiding layer (a).

Spatially separated measurement areas (d) are defined by an area that is occupied by biological, biochemical or synthetic recognition elements immobilized thereon, for recognition of one or multiple analytes in a liquid sample. These areas can have any geometry and, for example, be in the form of dots, circles, rectangles, triangles, ellipses or lines. Different measurement areas (d) can be separated from one another by the grating structures (c) and (c′), if a disturbing cross-talk of luminescence light generated in adjacent measurement areas (d) and coupled into the layer (a) is to be prevented. Different measurement areas (d) can also be located on a common, continuous grating structure, which, depending on the coupling efficiency of the grating, will result in a partial or complete prevention of disturbing cross-talk of luminescence.

The luminescence light that is coupled back into the optically transparent, waveguiding layer propagates isotropically in this layer, and makes it possible to incouple excitation light into the waveguiding layer and outcouple backcoupled luminescence light out of this layer using one and the same grating structure. Therefore, the grating structure (c) or (c′) can be used both as an incoupling grating and as an outcoupling grating.

As both the excitation light and backcoupled luminescence light can be coupled out with an adequate grating structure (c) already at the location of the incoupling, the incoupling and outcoupling efficiency essentially being determined by the adequate choice of the grating depth, a very high density of measurement areas on a common grating structure can be achieved.

The achievable density is essentially determined by the minimum spot size that can be achieved upon immobilization of the biological, biochemical or synthetic recognition elements. The sensor platforms can have areas with a lateral length of several centimeters. Therefore, a 2-dimensional arrangement up to 100,000 measurement areas can be provided on one sensor platform. A single measurement area can have an area of 0.001-6 mm².

A sensor platform of the present invention is dedicated for the simultaneous determination of one or more luminescences from at least two or more, laterally separated measurement areas (d) or at least two or more segments (d′) comprising several measurement areas (d), on the platform. The sensor platform has an optical film waveguide with a first optically transparent layer (a) on a second optically transparent layer (b) of lower refractive index than the layer (a), a grating structure (c) for incoupling excitation light to the measurement areas (d), the grating structure (c) being continuously modulated in the area of the at least two or more measurement areas (d) or of the at least two or more laterally separated segments (d′) comprising several measurement areas (d) and similar or different biological, biochemical or synthetic recognition elements (e) immobilized in the measurement areas (d), for a qualitative or quantitative determination of one or more analytes in a sample contacted with the measurement areas (d), wherein the density of the measurement areas (d) on the sensor platform is at least 16 measurement areas per square centimeter, and a cross-talk of a luminescence, generated in the measurement areas (d) or within a segment (d′) and coupled back into the optically transparent layer (a) of the film waveguide, to adjacent measurement areas (d) or adjacent segments (d′) is prevented upon outcoupling of this luminescence light by the grating structure (c), that is continuously modulated in the area of the measurement areas (d) or segments (d′).

This embodiment of the sensor platform is additionally characterized by the advantage, that the intensity of disturbing transmission light has a minimum, almost disappears, when the incoupling angle is met, i.e., resulting in a minimization of the excitation light not contributing to luminescence excitation in an optical system when the excitation light is launched from the back side of the sensor platform, i.e., entering through the optically transparent layer (b) and directed towards the grating structure. The physical conditions for the disappearance of the transmission light and the simultaneous appearance of an extraordinary “reflection” (as the sum of the regular portion of the reflection, in accordance with the radiation laws, and of the light that is outcoupled by the grating structure) are, for example, described and explained in D, Rosenblatt et al., “Resonant Grating Waveguide Structures”, IEEE Journal of Quantum Electronics, vol. 33 (1997)2038-2059.

For applications with reduced requirements on sensitivity, it can be advantageous if the excitation light is not launched at ideal incoupling conditions, but in a simple arrangement of direct or transmission light illumination to the measurement areas (d). Also in this arrangement, there will be an enhancement of luminescence in the near field of the optical (stratified) waveguide), and again, a high feature density, without an optical cross-talk of signals from adjacent measurement areas (d) can be achieved by outcoupling of the signals with a grating structure.

Another sensor platform of the present invention for the simultaneous determination of one or more luminescences from at least two or more, laterally separated measurement areas (d) or at least two or more segments (d′) comprising several measurement areas (d), on the platform. The sensor platform has an optical film waveguide with a first optically transparent layer (a) on a second optically transparent layer (b) of lower refractive index than the layer (a), the grating structure (c) that is continuously modulated in the area of the at least two or more laterally separated measurement areas (d) or of the at least two or more laterally separated segments (d′) comprising several measurement areas (d) and similar or different biological, biochemical or synthetic recognition elements (e) immobilized in the measurement areas (d), for a qualitative or quantitative determination of one or more analytes in a sample contacted with the measurement areas, wherein the density of the measurement areas (d) on the sensor platform is at least 16 measurement areas per square centimeter, and a cross-talk of a luminescence, generated in the measurement areas (d) or within a segment (d′) and coupled back into the optically transparent layer (a) of the film waveguide, to adjacent measurement areas (d) or adjacent segments (d′) is prevented upon outcoupling of this luminescence light by the grating structure (c) that is continuously modulated in the area of the measurement areas.

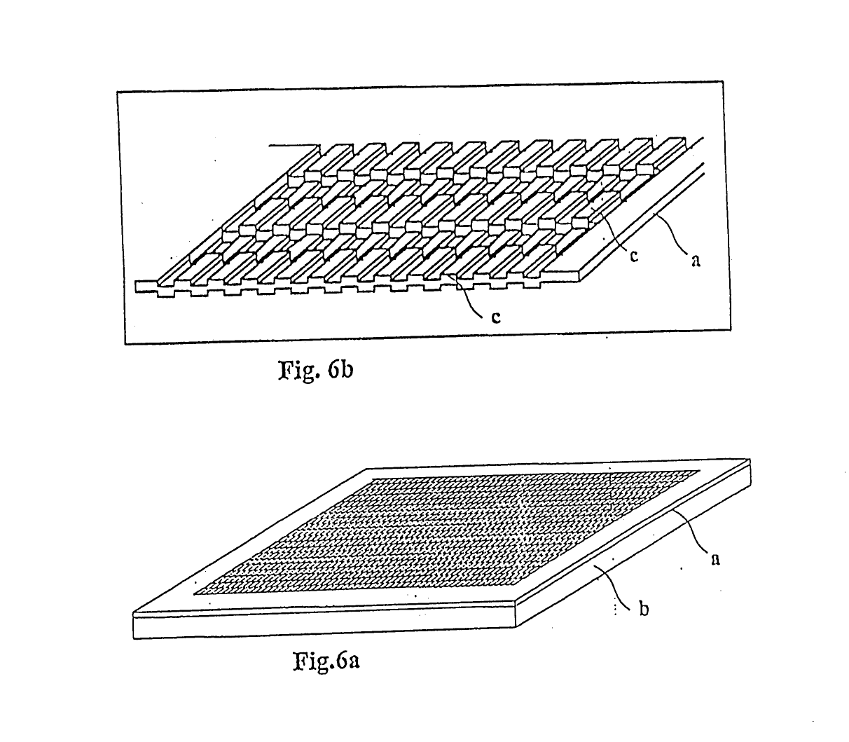

For many applications, especially in the field of biology, it is desired to use excitation of different excitation wavelengths and luminophores of different excitation wavelengths and similar or different emission wavelengths, or excitation light of similar excitation wavelength and luminophores of different emission wavelengths, for purposes of referencing using a control substance or for purposes of calibration. Then, it is advantageous if the grating structure, continuously modulated in the area of the two or more measurement areas or segments, is a superposition of two or more grating structures of different periodicities (see FIGS. 6a and 6b ) for the incoupling of excitation light of different wavelengths. The grating lines can be orientated in parallel or not in parallel, but preferably not in parallel, to each other. However, in the case of two superimposed grating structures, their grating lines are preferably perpendicular to each other.

The amount of the propagation losses of a mode guided in the optically waveguiding layer (a) is determined to a large extent by the surface roughness of a supporting layer below and by the absorption of chromophores which might be contained in this supporting layer, which is additionally associated with the risk of excitation of unwanted luminescence in this supporting layer, upon penetration of the evanescent field of the mode guided in the layer (a) (into this supporting layer). Furthermore, thermal stress can occur due to different thermal expansion coefficients of the optically transparent layers (a) and (b). In the case of a chemically sensitive optically transparent layer (b), consisting, for example, of a transparent thermoplastic plastic, it is desirable to prevent penetration, for example through micro pores in the optically transparent layer (a), of solvents that might attack layer (b).

Therefore, it is advantageous if an additional optically transparent layer (b′) (see FIG. 5b) with a lower refractive index than the layer (a) and in contact with the layer (a), and with a thickness of 5 nm-10 000 nm, preferably of 10 nm-1000 nm, is located between the optically transparent layers (a) and (b). The purpose of the intermediate layer (b′) is to reduce the surface roughness below the layer (a), to reduce the penetration of the evanescent field of light guided in layer (a), into the one or more layers located below, to improve the adhesion of the layer (a) to the one or more layers located below, to reduce thermally induced stress within the optical sensor platform, or to chemically isolate the optically transparent layer (a) from layers located below by sealing micro pores in the layer (a) against the layers located below.

There are many methods for the deposition of the biological, biochemical or synthetic recognition elements on the optically transparent layer (a). For example, the deposition can be performed by physical adsorption or electrostatic interaction. In general, the orientation of the recognition elements is that of a statistic nature. Additionally, there is the risk of washing away a part of the immobilized recognition elements, if the sample containing the analyte and reagents applied in the analysis process have a different composition. Therefore, it can be advantageous if an adhesion-promoting layer (f) (see FIG. 5b) is deposited on the optically transparent layer (a) for immobilization of biological, biochemical or synthetic recognition elements. This adhesion-promoting layer (f) should be transparent as well. Further, the thickness of the adhesion-promoting layer (f) should not exceed the penetration depth of the evanescent field out of the waveguiding layer (a) into the medium located above. Therefore, the adhesion-promoting layer (f) should have a thickness of less than 200 nm, and preferably of less than 20 nm. The adhesion-promoting layer (f) can comprise, for example, chemical compounds of the group comprising silanes, epoxides, and “self-organized functionalized monolayers”.

As stated in the definition of the measurement areas (d), laterally separated measurement areas (d) can be generated by laterally selective deposition of biological, biochemical or synthetic recognition elements on the sensor platform. When brought into contact with an analyte capable of luminescence or with a luminescently marked analogue of the analyte competing with the analyte for the binding to the immobilized recognition elements or with a luminescently marked binding partner in a multi-step assay, these molecules capable of luminescence will selectively bind to the surface of the sensor platform only in the measurement areas (d), which are defined by the areas occupied by the immobilized recognition elements.

For the deposition of the biological, biochemical or synthetic recognition elements, one or more methods of the group of methods comprising ink jet spotting, mechanical spotting, micro contact printing, fluidic contacting of the measurement areas with the biological or biochemical or synthetic recognition elements upon their supply in parallel or crossed micro channels, upon application of pressure differences or electric or electromagnetic potentials, can be applied.

Components of the group comprising nucleic acids (DNA, RNA, . . . ) and nucleic acid analogues (PNA . . . ), antibodies, aptamers, membrane-bound and isolated receptors, their ligands, antigens for antibodies, “histidine-tag components”, cavities generated by chemical synthesis, for hosting molecular imprints. etc., can be deposited as biological or biochemical, synthetic recognition elements.

With the last-named type of recognition elements are meant cavities, that are produced by a method described in literature as “molecular imprinting”. In this procedure, the analyte or an analyte-analogue, mostly in organic solution, is encapsulated in a polymeric structure. This it is called an “imprint”. Then, the analyte or its analogue is dissolved from the polymeric structure upon the addition of adequate reagents, leaving an empty cavity in the polymeric structure. This empty cavity can then be used as a bindung site with high steric selectivity in a later method of analyte determination. Also, whole cells or cell fragments can be deposited as biological or biochemical or synthetic recognition elements.

In many cases, the detection limit of an analytical method by signals caused by so-called nonspecific binding, i.e., by signals caused by the binding of the analyte or of other components applied for analyte determination, which are not only bound in the area of the provided immobilized biological, biochemical or synthetic recognition elements, but also in areas of a sensor platform that are not occupied by these recognition elements, for example upon hydrophobic adsorption or electrostatic interactions. Therefore, it is advantageous if compounds that are “chemically neutral” towards the analyte are deposited between the laterally separated measurement areas (d), in order to minimize nonspecific binding or adsorption. As “chemically neutral” compounds, as such components are called, which themselves do not have specific binding sites for the recognition and binding of the analyte, or of an analogue of the analyte or of a further binding partner in a multistep assay and which prevent, due to their presence, the access of the analyte, of its analogue, or of the further binding partners to the surface of the sensor platform. Compounds of the groups comprising, for example, bovine serum albumin or poly ethylene glycol, can be applied as “chemically neutral” compounds.

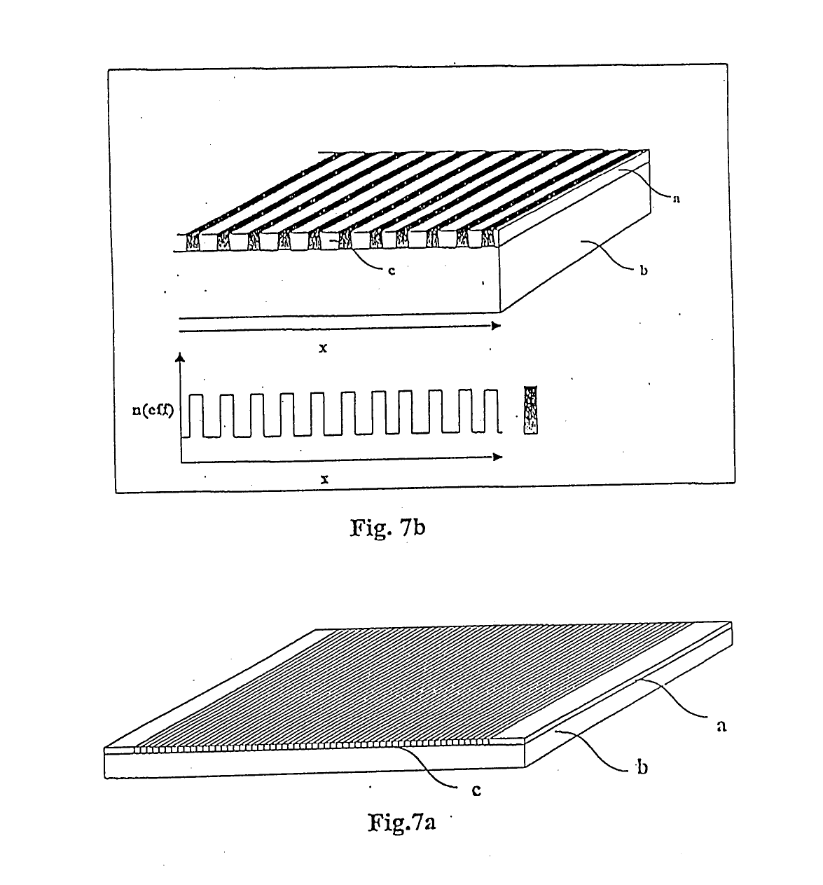

For many applications, it is advantageous if the grating structure (c) is a diffractive grating with a uniform period (see FIGS. 7a and 7b ). Then, the resonance angle for incoupling of the excitation light by the grating structure (c) towards the measurement areas is uniform in the whole area of the grating structure. If it is intended, however, to incouple excitation light from different light sources of significantly different wavelengths, the corresponding resonance angles for the incoupling can differ considerably, which can lead to the need for additional components for adjustment in an optical system housing the sensor platform or to spatially very unfavorable coupling angles. For example, for reducing large differences of coupling angles, it can be advantageous, if the grating structure (c) is a multidiffractive grating.

For reducing the requirements on the parallism of the excitation light bundle and on the exact adjustment of the resonance angle, it can be advantageous if the grating structure (c) has a laterally varying periodicity in parallel or perpendicular to the direction of propagation of the incoupled light in layer (a). Then, out of a convergently or divergently launched ray bundle illuminating a large area, an incoupling will occur at that location on the grating structure where the resonance condition is satisfied.

In addition, such a grating structure with a laterally varying periodicity in parallel or perpendicular to the direction of propagation of the incoupled light in layer (a) enables a method, wherein, besides the determination of one or more luminescences, changes of the effective refractive index on the measurement areas can be determined. For this method, it can be advantageous if the one or more luminescences and/or determinations of light signals at the excitation wavelength are performed in a polarization-selective way.

For improving the signal-to-background ratio, it can be advantageous if the one or more luminescences are measured at a polarization different from the one of the excitation light.

The material of the second optically transparent layer (b) can comprise quartz, glass, or transparent thermoplastic plastics of the group comprising, for example, poly carbonate, poly imide, or poly methylmethacrylate.

For generating an evanescent field that is as strong as possible at the surface of the optically transparent layer (a), it is desirable that the refractive index of the waveguiding, optically transparent layer (a) is significantly higher than the refractive index of the adjacent layers. It is especially advantageous if the refractive index of the first optically transparent layer (a) is higher than 2.

The first optically transparent layer (a) can comprise, for example, TiO₂, ZnO, Nb₂O₅, Ta₂O₅, HfO₂, or ZrO₂. It is especially preferred if the first optically transparent layer (a) comprises TiO₂ or Ta₂O₅.

Besides the refractive index of the waveguiding optically transparent layer (a), the thickness of the waveguiding optically transparent layer is the second important parameter for the generation of an evanescent field that is as strong as possible at the interfaces to adjacent layers with lower refractive indexes. With decreasing thickness of the waveguiding layer (a), the strength of the evanescent field increases, as long as the layer thickness is sufficient for guiding at least one mode of the excitation wavelength. Thereby, the minimum “cut-off” layer thickness for guiding a mode is dependent on the wavelength of this mode. The “cut-off” layer thickness is larger for light of longer wavelength than for light of shorter wavelength. As the “cut-off” layer thickness approaches, however, unwanted propagation losses increase strongly, thus additionally setting a lower limit for the choice of the preferred layer thickness.

Preferred are layer thicknesses of the optically transparent layer (a) allowing for guiding only one to three modes at a given excitation wavelength. Especially preferred are layer thicknesses resulting in monomodal waveguides for this given excitation wavelength. It is understood that the character of discrete modes of the guided light does only refer to the transversal modes. Resulting from these requirements, the thickness of the first optically transparent layer (a) is preferably between 40 and 300 nm. It is especially advantageous, if the thickness of the first optically transparent layer (a) is between 70 and 160 nm.

For given refractive indices of the waveguiding, optically transparent layer (a) and of the adjacent layers, the resonance angle for incoupling of the excitation light, according to the above mentioned resonance condition, is dependent on the diffraction order to be incoupled, on the excitation wavelength, and on the grating period. Incoupling of the first diffraction order is advantageous for increasing the incoupling efficiency. Besides the number of the diffraction order, the grating depth is important for the amount of the incoupling efficiency. As a matter of principle, the coupling efficiency increases with increasing grating depth. The process of outcoupling being completely reciprocal to the incoupling, however, the outcoupling efficiency increases simultaneously, resulting in an optimum grating depth for the excitation of luminescence in the measurement area (d) located on or adjacent to the grating structure (c), the optimum grating depth being dependent on the geometry of the measurement areas and of the launched excitation light bundle. Based on these boundary conditions, it is advantageous if the grating (c) has a period of 200 nm-1000 nm and a modulation depth of 3 nm-100 nm, and preferably of 10 nm-30 nm.

As demonstrated in the exemplary embodiment of this invention below, it is possible to generate on a continuous grating structure by incomplete incoupling and outcoupling of excitation light and/or backcoupled luminescence light, a positive gradient of the intensity of guided excitation light and/or generated luminescence light within a single measurement area and/or across several measurement areas parallel to the direction of propagation of the incoupled excitation light, which gradient can be controlled by the grating depth. This gradient results from outcoupling a portion of the excitation light that is smaller than the amount of excitation light that is additionally incoupled in the direction of propagation of the incoupled excitation light, along the respective area of the grating structure illuminated simultaneously, under incoupling conditions with an expanded, essentially parallel excitation light bundle. Under these conditions, as a consequence, the total available excitation light intensity increases towards the end of the illuminated area on the continuous grating structure in the direction of propagation of the guided light. This gradient of the intensity of available excitation light has the advantage that it can be used for an extension of the dynamic range.

For given residual parameters, the incoupling and outcoupling efficiency is essentially determined by the grating depth. Therefore, the gradient of the intensity of guided excitation light and/or of excited luminescence light can additionally be affected and controlled if the grating (c) has a laterally varying grating depth parallel to the direction of propagation of the incoupled excitation light.

In contrast, propagation losses of the incoupled excitation light in an optically transparent, waveguiding layer lead to a negative gradient of the guided excitation light along its direction of propagation. Correspondingly, a negative gradient of the intensity of guided excitation light and/or generated luminescence light within a single measurement area and/or across several measurement areas, that can be controlled by the extent of the propagation losses in the optically transparent layer (a), can be generated parallel to the direction of propagation of the incoupled excitation light. The extent of the propagation losses can, for example, be regulated by a specific doping of the waveguiding layer with absorbent molecules not interfering with the luminescence to be generated, or by deposition of such absorbent molecules on the waveguiding layer.

Further, it is preferred that the ratio of the modulation depth of the grating to the thickness of the first optically transparent layer (a) is equal or smaller than 0.2. Thereby, the grating structure (c) can be a relief grating with a rectangular, triangular or semi-circular profile, or a phase or volume grating with a periodic modulation of the refractive index in the essentially planar, optically transparent layer (a).

Further, for the enhancement of a luminescence or for the improvement of the signal-to-noise ratio, it can be advantageous if a thin metal layer, preferrably of gold or silver, is deposited between the optically transparent layer (a) and the immobilized biological, biochemical or synthetic recognition elements, optionally on an additional dielectric layer, for example of silica or magnesium fluoride, with a lower refractive index than the layer (a), wherein the thickness of the metal layer and of the optional additional intermediate layer is selected in such a way that a surface plasmon can be excited at the excitation wavelength and/or at the luminescence wavelength.

In addition, it can be advantageous if optically or mechanically recognizable marks for simplifying adjustments in an optical system and/or for the connection to sample compartments, as part of an analytical system, are provided on the sensor platform.

Another object of this invention is an optical system for the determination of one ormore luminescence. The optical system has at least one excitation light source (100), a sensor platform according to at least one of the above embodiments, and at least one detector (200) for the collection of the light emanating from one or more of the measurement areas (d) on the sensor platform.

For applications without the highest requirements on sensitivity, it can be advantageous if the excitation light is launched to the measurement areas in a simple arrangement of direct or transmission illumination. Such an arrangement is associated with significantly reduced requirements on the positioning of a sensor platform, according to the invention, in an optical system. Such an arrangement allows for the usage of the sensor platform in many commercial luminescence excitation and detection systems, such as scanner systems. Thereby, it is preferred that the detection of the luminescence light is performed in such a way that the luminescence light outcoupled by a grating structure (c) or (c′) is collected by the detector as well. For achieving the deepest detection limits, however, it is advantageous if the excitation light is launched at the grating structure (c) or (c′) under incoupling conditions. Thereby, it is advantageous if the excitation light emitted from the at least one light source is coherent and is launched to the one or more measurement areas at the resonance angle for coupling into the optically transparent layer (a).

For reducing luminescence signals emanating from the outside of the measurement areas, however, it can also be advantageous if the excitation light from the at least one light source is divided into a plurality of individual rays of a uniform as possible intensity by a diffractive optical element, or in a case of multiple light sources, by multiple diffractive optical elements, which are preferably Dammann gratings, or by refractive optical elements, which are preferably microlens arrays, the individual rays being launched essentially parallel to each other to laterally separated measurement areas.

In a case of insufficient intensity of a single light source or in a case of a need for light sources with different emission wavelenghts, for example for biological applications, it is advantageous if two or more coherent light sources of similar or different emission wavelength are used as excitation light sources. In the case of light sources of different emission wavelengths it is then advantageous if the excitation light from two or more coherent light sources is launched simultaneously or sequentially from different directions on the grating structure (c), which comprises a superposition of grating structures of different periodicity.

In order to record the signals from a multitude of measurement areas separately, it is preferred to use a laterally resolving detector for signal detection. Thereby, at least one detector of the group comprising, for example, CCD cameras, CCD chips, photodiode arrays, avalanche diode arrays, multichannel plates and multichannel photomultipliers, can be used as the at least one laterally resolving detector.

In the optical system according to the invention, and according to any of the described embodiments, optical components (400) of the group comprising lenses or lens systems for the shaping of the transmitted light bundles, planar or curved mirrors for the deviation and optionally additional shaping of the light bundles, prisms for the deviation and optionally spectral separation of the light bundles, dichroic mirrors for the spectrally selective deviation of parts of the light bundles, neutral density filters for the regulation of the transmitted light intensity, optical filters or monochromators for the spectrally selective transmission of parts of the light bundles, or polarization selective elements for the selection of discrete polarization directions of the excitation or luminescence light can be located between the one or more excitation light sources and the sensor platform according to any of the described embodiments and/or between the sensor platform and the one or more detectors.

For many applications, it is advantageous if the excitation light is launched in pulses with a duration of 1 fsec to 10 min. For kinetic measurements or for the discrimination of fast decaying fluorescence from fluorescent contaminations in the sample, in materials of the optical system, or of the sensor platform itself, it can be advantageous if the emission light from the measurement areas is measured time-resolved.

Further, it is preferred, for referencing purposes, that the optical system according to the invention comprises components for measuring light signals of the group comprising excitation light at the location of the light sources, after expansion of the excitation light or after its division into individual beams, scattered light at the excitation wavelength from the location of the one or more laterally separated measurement areas (d), and light of the excitation wavelength outcoupled by the grating structure (c) besides the measurement areas (d). Thereby, it is especially advantageous if the measurement areas for determination of the emission light and of the reference signal are identical.

Launching of the excitation light and detection of the emission light from the one or more measurement areas (d) can also be performed sequentially for one or more measurement areas (d). Thereby, sequential excitation and detection can be performed using movable optical components of the group comprising mirrors, deviating prisms, and dichroic mirrors. Typically, commercially available so-called scanners are used for sequential excitation and detection in bioanalytical array-imaging systems, wherein an excitation light beam is scanned sequentially, mostly by movable mirrors, over the area to be analyzed. In the case of most scanning systems, the angle between the illuminated area and the excitation light beam is changed. To satisfy the resonance condition for the incoupling of the excitation light into the waveguiding layer of the sensor platform according to the invention, however, this angle should essentially remain constant, i.e., a scanner to be implemented in the optical system according to the invention has to function in an angel-preserving manner. This requirement is satisfied by some commercially available scanners. At the same time, however, the size of the excited area on the sensor platform should not be changed. Therefore, another subject of the invention is an optical system, wherein sequential excitation and detection is performed using an essentially focus and angle preserving scanner. In another embodiment, the sensor platform is moved between steps of sequential excitation and detection. In this case, the one or more excitation light sources and the components used for detection can be located at spatially fixed positions.

Another subject of the invention is a complete analytical system for the determination of one or more analytes in at least one sample on one or more measurement areas (d) on a sensor platform by luminescence detection. The analytical system has an optical film waveguide, a sensor platform according to any of the described embodiments, an optical system according to any of of the described embodiments, and supply means (500) for bringing the one or more samples into contact with the measurement areas (d) on the sensor platform.

It is advantageous if the analytical system additionally comprises one or more sample compartments (defined by walls g), which are at least in the area of the one or more measurement areas (d) or of the measurement areas (d) combined to segments (d′) open towards the sensor platform. Thereby, the sample compartments can each have a volume of 0.1 nl-100 μl.

The sensor platform can be operated both in a closed flow system and in an open system. In the first case, the analytical system is constructed in such a way that the sample compartments are closed, except for inlet and/or outlet openings for the supply or outlet of samples, at a side of the sample compartments opposite to the optically transparent layer (a), and wherein the supply or the outlet of the samples and optionally of additional reagents is performed in a closed flow through system. In the case of liquid supply to several measurement areas (d) or segments (d′) with common inlet and outlet openings, these openings are preferably addressed row by row or column by column.

In case of an open system, the analytical system according to the invention is constructed in such a way that the sample compartments have openings for locally addressed supply or removal of samples or other reagents at a side of the sample compartments opposite to the optically transparent layer (a). Additionally, compartments for reagents may be provided, the reagents being wetted during the assay for the determination of the one or more analytes and being in contact with the measurement areas.

A further subject of this invention is a method for the simultaneous determination by luminescence detection of one or more analytes in one or more samples on at least two or more, laterally separated measurement areas on a sensor platform for the simultaneous determination of one or more luminescences from an array of at least two or more laterally separated measurement areas (d) or at least two or more laterally separated segments (d′) comprising several measurement areas (d) on the platform. The method uses an optical film waveguide with a first optically transparent layer (a) on a second optically transparent layer (b) of lower refractive index than the layer (a), a grating structure (c) that is continuously modulated in the area of the at least two or more laterally separated measurement areas (d) or of the at least two or more laterally separated segments (d′) comprising the several measurement areas (d) and similar or different biological, biochemical or synthetic recognition elements (e) immobilized in the measurement areas (d), for the qualitative or quantitative determination of one or more analytes in a sample contacted with the measurement areas, wherein the density of the measurement areas (d) on the sensor platform is at least 16 measurement areas per square centimeter, and a cross-talk of a luminescence, generated in the measurement areas (d) or within a segment (d′) and coupled back into the optically transparent layer (a) of the film waveguide, to adjacent measurement areas or adjacent segments is prevented upon outcoupling of this luminescence light by the grating structure (c), that is continuously modulated in the area of the measurement areas (d) or segments (d′). Thereby, it is preferred that the excitation light for the measurement areas (d) is coupled into the optically transparent layer (a) by the grating structure (c).

The methods according to the invention described above allow for measuring (1) the isotropically emitted luminescence, (2) the luminescence that is coupled back into the optically transparent layer (a) and outcoupled by the grating structure (c) or (3) luminescences of both pails (1) and (2) simultaneously.

Another subject of the invention a method for the determination of one or more analytes by luminescence detection, using an analytical system according any of the embodiments described above. The method uses an optical system according to any of the embodiments described above, with a sensor platform according to at least one of the embodiments described above, wherein one or more liquid samples, to be tested for the one or more analytes, are brought into contact with one or more measurement areas (d) on the sensor platform, excitation light is directed to the measurement areas (d), compounds in the samples or on the measurement areas, capable to luminesce, are excited to emit luminescence, and the emitted luminescence is measured.

As a further development, the dynamic range for signal measurement and/or quantitative analyte determination can be increased or limited by a controllable gradient of guided excitation light and/or excited luminescence light parallel to the direction of propagation of the incoupled excitation light, within one and/or across several measurement areas.

For the generation of luminescence or fluorescence, in the method according to the invention, a luminescence or fluorescence label can be used, which can be excited and emits at a wavelength between 300 nm and 1100 nm. The luminescence or fluorescence labels can be conventional luminescence or fluorescence dyes, or also luminescent or fluorescent nanoparticles, based on semiconductors (W. C. W. Chan and S. Nie, “Quantum dot bioconjugates for ultrasensitive nonisotopic detection”, Science 281 (1998) 2016-2018).

The luminescence label can be bound to the analyte or, in a competitive assay, to an analyte analogue or, in a multi-step assay, to one of the binding partners of the immobilized biological, biochemical or synthetic recognition elements, or to the biological, biochemical or synthetic recognition elements.

Additionally, a second or greater number of luminescence labels of similar or different excitation wavelengths as the first luminescence label and similar or different emission wavelengths can be used. Thereby, it can be advantageous if the second or more luminescence labels can be excited at the same wavelength as the first luminescence label, but emit at other wavelengths.

For other applications, it can be advantageous, if the excitation and emission spectra of the applied luminescent dyes do not overlap or only partially overlap.

In the method according to the invention, it can be further advantageous if charge or optical energy transfer from a first luminescent dye, acting as a donor, to a second luminescent dye, acting as an acceptor, is used for the detection of the analyze.

Additionally, it can be advantageous if, besides the determination of one or more luminescences, changes of the effective refractive index on the measurement areas are determined. Thereby, it can be of further advantage if the one or more luminescences and/or determinations of light signals at the excitation wavelengths are performed as polarization-selective. Further, the method allows for the measurement of the one or more luminescences at a polarization that is different from the one of the excitation light.

The method according to the invention allows for the simultaneous or sequential, quantitative or qualitative determination of one or more analytes of the group comprising antibodies or antigens, receptors or ligands, chelators or “histidine-tag components”, oligonucleotides, DNA or RNA strands, DNA or RNA analogues, enzymes, enzyme cofactors or inhibitors, lectins and carbohydrates.

The samples to be examined can be naturally occurring body fluids, such as blood, serum, plasma, lymph or urine, or egg yolk. A sample to be examined can also be an optically turbid liquid, surface water, a soil or plant extract, or a bio- or process broth. The samples to be examined can also be taken from biological tissue.

In addition, any of the methods described above can be used for numerous purposes, including the determination of chemical, biochemical or biological analytes in screening methods in pharmaceutical research, combinatorial chemistry, clinical and preclinical development, for real-time binding studies and the determination of kinetic parameters in affinity screening and in research, qualitative and quantitative analyte determinations, especially for DNA- and RNA analytics, for the generation of toxicity studies and the determination of expression profiles and for the determination of antibodies, antigens, pathogens or bacteria in pharmaceutical product development and research, human and veterinary diagnostics, agrochemical product development and research, for patient stratification in pharmaceutical product development and for the therapeutic drug selection, for determination of pathogens, nocuous agents and germs, especially of salmonella, prions and bacteria, in food and environmental analytics.

The invention will be further explained and demonstrated in the following examples.

### EXAMPLE 1

(a) Sensor Platform With Two Separate Grating Structures and Multiple Measurement Areas and A Segment of Measurement Areas

A sensor platform with the exterior dimensions of 16 mm width×48 mm length×0.5 mm thickness as illustrated in Figures was used. The substrate material (optically transparent layer (b)) consisted of Corning glass 7059 (refractive index n=1.538 at 488 nm). Two structures of surface relief gratings, with a period of 320 nm and a grating depth of 12+/−3 nm, were generated in the substrate by holographic exposure of the layer (b) covered with a photo resist deposited by spin-coating, followed by wet chemical etching, while masking of the areas not to be structured on the sensor platform. The gratings had a dimension of 5 mm length×12 mm width (grating structure I) and 1 mm length×12 mm width (grating structure II), respectively, with an orientation of the grating lines in parallel to the given width of the sensor platform. The grating structures were arranged in a centrally symmetric manner on the sensor platform with respect to their inner sides for the excitation light to be incoupled and guided in the waveguiding layer (a), with an inside distance of 20 mm. The waveguiding, optically transparent layer (a) on the optically transparent layer (b) was generated upon ion plating, followed by tempering at 300° C. (see R. E. Kunz, J. Edlinger et al., “Grating couplers in tapered waveguides for integrated optical sensing”, in Proc. SPIE vol. 2068 (1994), page 321), and had a refractive index of 2.317 at 488 nm (layer thickness 150 nm). The grating depths of the waveguiding layer (a), into which the grating structure is transferred to be almost 1:1 according to scale upon the deposition process, were later controlled by AFM (atomic force microscopy). In the example below (Example 4(b)) Method of Measurement), the grating structures (I) are used as continuous grating structures for the incoupling of the excitation light to the measurement areas on top, respective to the measurement areas located between the grating structures (I) and (II). The latter measurement areas, forming a segment, are prevented, by outcoupling of guided, backcoupled luminescence light and of guided excitation light by grating structure (II), from cross-talk to possible further measurement areas or segments located beyond the grating structure (II), in this case serving as an outcoupling grating.

As a preparation for the immobilization of the biochemical or biological or synthetic recognition elements, the sensor platforms were cleaned and silanized with epoxy silane in the liquid phase (10 ml (2% v/v) 3-glycidyloxypropyltrimethoxy silane and 1 ml (0.2% v/v) N-ethyldiisopropyl amine in 500 ml orto-xylene (d=0.881 g/cm³, m=440.5 g)). Then, solutions of 16-mer oligonucleotides (NH2-3′CAACACACCTTAACAC-5′; concentration of deposited solution: 0.34 mM; 3 nl per spot) were deposited with a commercial spotter, thus generating almost circular measurement areas with a diameter of 140-150 μm in a distance of 600 μm (center-to-center), in a 6×6 array, both on the grating structure (I) and in the area between the grating structures (I) and (II).

(b) Sensor Platform With Multiple Sensing Areas on a Continuous Grating Structure

A sensor platform with the exterior dimensions of 16 mm width×48 mm length×0.7 mm thickness was used. The substrate material (optically transparent layer (b)) consisted of AF 45 glass (refractive index n=1.52 at 633 nm). A continuous structure of a surface relief grating, with a period of 364 nm and a grating depth of 25+/−5 nm, was generated in the substrate by holographic exposure of the layer (b) covered with a photo resist deposited by spin-coating, followed by wet chemical etching, with orientation of the grating lines in parallel to the given width of the sensor platform. The waveguiding, optically transparent layer (a) of Ta₂O₅ on the optically transparent layer (b) was generated upon reactive, magnetic field-enhanced DC-sputtering (see DE 4410258), and had a refractive index of 2.15 at 633 nm (layer thickness 150 nm). The grating depths of the waveguiding layer (a), into which the grating structure is transferred to be almost 1:1 according to scale upon the deposition process, were later controlled by AFM (atomic force microscopy).

As a preparation for the immobilization of the biochemical, biological or synthetic recognition elements, the sensor platforms were cleaned and silanized with epoxy silane in the liquid phase, as described above. Then, solutions of 16-mer oligonucleotides (concentration of deposited solution: 0.34 mM; 3 nl per spot) were deposited with a commercial spotter, thus generating almost circular measurement areas with a diameter of 140-150 μm in a distance of 600 μm (center-to-center), in a 6×6 array on the continuous grating structure.

### EXAMPLE 2

### Optical System

(a) Excitation Modules

The sensor platform is mounted on a computer-controlled adjustment module, allowing for translation in parallel and perpendicular to the grating lines and for rotation with center of motion in the main axis of the area illuminated by the excitation light beam launched onto the grating structure (I) for incoupling into the sensor platform named in Example 1(a). Immediately after the laser acting as an excitation light source, there is a shutter in the light path, in order to block the light path when measurement data shall not be collected. Additionally, neutral density filters or polarizers can be mounted at this or also other positions in the path of the excitation light towards the sensor platform, in order to vary the excitation light intensity step-wise or continuously.

Excitation Module (a)(i)/Sensor Platform 1(a)

The excitation light beam from a helium neon laser (2 mW) is launched, without use of additional beam-shaping components, onto the right edge of the grating structure I. The size of the excitation light spot corresponds to the diameter of the exciting laser beam. The sensor platform is adjusted to maximum incoupling, which is confirmed by a maximum intensity of scattered light that is emitted by scattering along the incoupled mode of guided excitation light. This maximum can be determined both by visual inspection and by imaging of the scattered light along the excitation mode collected by an imaging system onto an optoelectronic detector, such as the pixels of a CCD camera, as an example of a laterally resolving detector, or a photodiode, as an example of a laterally non-resolving detector. Under the same incoupling conditions, a maximum signal is also measured with a second optoelectronic detector positioned at the outcoupling angle of the second grating structure II for the guided excitation light. An angle of −3.8° is determined as the resonance angle for incoupling.

Excitation Module (a)(ii)/Sensor Platform 1(a)

The excitation light beam from a helium neon laser (2 mW) is expanded by a combination of lenses, including a cylindrical lens, to a light beam with a slit-type cross-section (in parallel to the grating lines of the sensor platform). The upper and lower bordering regions of the excitation light bundle, being slightly divergent in parallel to the grating lines, but parallel in the projection orthogonal to the grating lines, are masked by a slit. The resulting light bundle with a slit-type cross-section on the grating structure is directed onto the right edge of grating structure I. The excitation light has a size of 1 mm length×12 mm width. The sensor platform is adjusted to maximum incoupling, which is confirmed by a maximum intensity of scattered light that is emitted by scattering along the incoupled mode of guided excitation light. This maximum can be determined both by visual inspection and by imaging of the scattered light along the excitation mode collected by an imaging system onto an optoelectronic detector, such as the pixels of a CCD camera, as an example of a laterally resolving detector, or a photodiode, as an example of a laterally non-resolving detector. Under the same incoupling conditions, a maximum signal is also measured with a second optoelectronic detector positioned at the outcoupling angle of the second grating structure II for the guided excitation light. An angle of −3.9° is determined as the resonance angle for incoupling.

Excitation Module (a)(iii)/Sensor Platform 1(a)

By means of a Dammann grating, the excitation light from a helium neon laser is divided into 16 individual beams, in a linear arrangement in parallel to the lines of this grating. The irregular sequence of the grating bars and grooves was optimized by the manufacturer in such a way that all even diffraction orders, especially the zero order, were suppressed, and an intensity as uniform as possible was achieved for the odd diffraction orders (with a variation below 5%). An aspheric lens behind the Dammann grating, in direction towards the sensor platform, the Dammann grating being in the focus of said lens, was used to form a bundle of parallel individual beams from the divergent ray bundle behind the Dammann grating. The divergence of the individual beams emanating from the Dammann grating and the focal length of the lens located behind the Dammann grating can be balanced in such a way that a desired spacing between the beams on the sensor platform is generated.

In the actual example, 16 individual beams were generated with the Dammann grating under use, 8 of which, after passing a slit-type aperture, were directed by a deviating prism onto the right edge of the grating structure I acting as an incoupling grating. The incoupling condition could be satisfied for all 8 individual beams simultaneously, as confirmed by simultaneous maximum intensity of the scattered light along the individual beams incoupled and guided in the waveguiding layer (a). The coupling angle was −3.8°.

Excitation Module (a)(iv)/Sensor Platform 1(a)

The excitation light beam from a helium neon laser at 632.8 nm is expanded to a parallel ray bundle of circular cross-section with 2 cm diameter, by a 25-fold expansion optics. From the central pail of this excitation light bundle, an area of 1 mm length×9 mm width (in accordance with the nomenclature for the grating structure) is selected and directed onto the right edge of the grating structure I (in the direction of the excitation light to be incoupled and guided). The sensor platform is adjusted for maximum incoupling, which is confirmed by maximum intensity of the scattered light that is emitted by scattering along the incoupled mode of guided excitation light. This maximum can be determined both by visual inspection and by imaging of the scattered light along the excitation mode collected by an imaging system onto an optoelectronic detector, such as the pixels of a CCD camera, as an example of a laterally resolving detector, or a photodiode, as an example of a laterally non-resolving detector. Under the same incoupling conditions, a maximum signal is also measured with a second optoelectronic detector positioned at the outcoupling angle of the second grating structure II for the guided excitation light.

An angle of −3.8° is determined as the resonance angle for incoupling. The amount of undiffracted, transmitted excitation light is measured behind the position of the sensor platform with a laser power meter. A value of 88 μW is determined as the available excitation intensity (without a sensor platform in the light path). The transmission amounts to 79 μW with a sensor platform placed in the light path, but without incoupling into the waveguiding layer. When incoupling occurs, this value is reduced to 21 μW, i.e., to 24% of the total available excitation light.

Excitation Module (a)(v)/Sensor Platform (1)(a)

The excitation light beam from a helium neon laser at 632.8 nm is expanded to a parallel ray bundle of circular cross-section with 2 cm diameter, by a 25-fold expansion optics. From the central part of this excitation light bundle, an area of 4 mm length×9 mm width (in accordance with the nomenclature for the grating structure) is selected and first directed onto the right edge of the grating structure I (in direction of the excitation light to be incoupled and guided). The sensor platform is adjusted for maximum incoupling, which is confirmed by maximum intensity of the light emitted by scattering along the incoupled mode of guided excitation light. An angle of −4° is determined as the resonance angle for incoupling. Then, the sensor platform is laterally translated, without a change of the angle, until the 4 mm long area illuminated with excitation light is located in the center of the 5 mm long grating structure. The amount of undiffracted, transmitted excitation light is measured behind the position of the sensor platform with a laser power meter. A value of 250 μW is determined as the available excitation intensity (without a sensor platform in the light path). The transmission amounts to 240 μW with a sensor platform placed in the light path, but without incoupling into the waveguiding layer. When incoupling occurs, this value is reduced to 51 μW, i.e., to 20% of the total available excitation light.

(b) Detection Modules

(i) Detection Systems for the Simultaneous Signal Recording from Multiple Measurement Areas

(I) A CCD camera (TE3/A Astrocam, Cambridge, UK) with peltier cooling (operation temperature: −30° C.) was used as a laterally resolving detector. Signal collection and focusing onto the CCD chip was performed by a 35 mm Nikon objective (Nikkor 35 mm). Two interference filters (Omega Optical, Brattleborough, Vt.) with central wavelength of 679 nm and 25 mn bandwidth were placed between the objective and the CCD chip in an only slightly convergent part of the optical path, and not significantly impairing the efficiency of the interference filters. The laterally resolved signals collected upon supply of the hybridization buffer, without a luminescent tracer probe, and with a temporal offset with respect to the luminescence signal upon hybridization with complementary, luminescently labeled tracer molecules were used both for determination of the background signal and for referencing.

(II) CCD camera (TE3/A Astrocam, Cambridge, UK) with peltier cooling (operation temperature: −30° C.) was used as a laterally resolving detector. Signal collection and focusing onto the CCD chip was performed by a Heligon Tandem objective (Rodenstock, 2×XR Heligon 1.1/50 mm). Two interference filters (Omega Optical, Brattleborough, Vt.), with a central wavelength of 679 nm and 25 nm bandwidth, and either a neutral density filter (for transmission of attenuated, scattered excitation light and of much weaker luminescence light from the measurement areas) or a neutral density filter in combination with an interference filter (for transmission of the attenuated excitation light from the measurement areas) were mounted on a filter wheel between the two parts of the Heligon Tandem objective. The signals at the excitation and the emission wavelength were measured alternately.

(III) A CCD camera (TE3/A Astrocam, Cambridge, UK) with peltier cooling (operation temperature: −30° C.) was used as a laterally resolving detector. Signal collection and focusing onto the CCD chip was performed by means of a Heligon Tandem objective, like in the previous example. Between the two parts of the Heligon Tandem objective were placed, in direction of the propagation of the emission light path towards the detector, a first a beam-splitting plate positioned under 45° with respect to the orthogonal reflection of the portion of light reflected by Fresnel reflections (mainly consisting of light at the excitation wavelength), followed by two interference filters (Omega Optical, Brattleborough, Vt.), with a central wavelength of 679 mn and 25 nm bandwidth, for selective transmission of luminescence light. The portion of light reflected out of the emission light path by the beam-splitting plate was directed onto a laterally resolving or non-resolving detector, either directly or after passing through an interference filter, for the excitation wavelength. The reference signals and the luminescence signals from the measurement areas, which always originate from the same areas on the sensor platform like in the above examples, were recorded simultaneously.

(ii) Detection Systems for Sequential Signal Recording From Measurement Areas

The measurement area on the sensor platform to be imaged is located in the focus of a lens system imaging the measurement area onto an aperture on a 1:1 scale. The aperture allows for masking areas outside of the measurement area of interest. The aperture itself is located in the focus of the first lens of a system comprising at least two lenses arranged to generate a parallel optical path behind the system in the direction towards the detector. In the parallel part of the optical path is located first a beam-splitting plate positioned under 45° with respect to the parallel light path, which is used to reflect, by Fresnel reflection, a part of the collected light comprising mainly scattered light at the excitation wavelength in the direction of the reference detector, such as a photodiode connected to an amplifier, optionally after the reflected light passes through an interference filter at the excitation wavelength. The transmitted luminescence light, further propagating behind the beam-splitting plate, is selected by two interference filters (Omega Optical, 679 DF25) and focused on a detector, which is a selected photomultiplier in combination with a photon-counting unit (Hamamatsu H6240-02 select).

For sequential recording of signals from different measurement areas, the sensor platform is translated into x- and y-directions by the positioning elements described in Example 2(a).

Also a combination of simultaneous excitation of multiple measurement areas and signal collection by laterally resolving detectors with translation steps, for signal collection from larger areas on the sensor platform than the areas that can be excited and detected in a single step, can be performed.

### EXAMPLE 3

### Analytical System

All examples listed below are designed in such a way that the sensor platforms with the associated sample compartments and the fluidic supply system each can be temperature-regulated as a whole or partially.

(a) A Single Continuous, Closed Flow Cell+Fluidic System

A sensor platform according to Example 1(a) is used together with an excitation module according to Example 2(a)(iv). A detection module according to Example 2(b)(i)(I) is selected. A closed sample compartment with a sample chamber opening towards the sensor platform, enclosing the whole area thereon, including the grating structures I and II, with a width of 8 mm, is used for sequential application of different reagents and the samples in a closed flow system. The material of the sample compartment advantageously consists of self-adhesive, flexible and fluidly sealing, low reflective plastics free of fluorescence, which is, in case of the actual example, blackened poly dimethylsiloxane. The depth of the sample chamber is 0.1 mm, resulting in 25 μl as the total volume of the sample chamber. The continuous sample chamber is used for the simultaneous application of one and the same sample or reagents to all measurement areas. Two openings that can be used interchangeably as an inlet or outlet are located at the left and right edge of the sample compartment at the side opposite to the sensor platform. The supply of the sample and reagents is performed using syringe pumps (Cavro XL 3000, Cavro, Sunnyvale, Calif., U.S.) with a dosage precision of 1 μl-10 μl, dependent on the size of the syringe. The syringe pumps are parts of a fluidic system further comprising a commercial auto-sampler (Gilson 231 XL), one or more multi-port valves, and a sample loop. Upon switching the one or more valves and actuation by the pumps, different reagents or samples can be directed to the measurement areas.

(b) Flow Cell With Five Parallel Closed Flow Channels+Fluidic System

A sensor platform according to Example 1(a) is used together with an excitation module according to Example 2(a)(ii). A detection module according to Example 2(b)(i)(I) is selected. For the sequential application of different reagents and the samples in a closed flow system, a closed flow cell with 5 parallel sample chambers opening towards the sensor platform, each of 1 mm width and a distance of 1 mm to each other, is used. The sample chambers extend beyond the grating structures I and II. The depth of the sample chambers is 0.1 mm, resulting in approximately 2.5 μl as the total volume of each sample chamber. The 5 sample chambers are used for application of similar or different reagents to the measurement areas addressed from the top. Two openings that can be used interchangeably as an inlet or outlet are located at the left and right edge of each sample compartment, at the side opposite to the sensor platform. The supply of the sample and reagents is performed using syringe pumps (Cavro XL 3000, Cavro, Sunnyvale, Calif., U.S.), with syringes of small size (50 μi-250 μl), allowing for a dosage precision of about 0.5 μl. The syringe pumps are parts of a fluidic system further comprising a commercial auto-sampler (Gilson 231 XL), one or more multi-port valves, and one or more sample loops. Upon switching of the one or more valves and actuation by the pumps, different reagents or samples can be directed to the measurement areas.

(c) Open Sample Vessels for Individually Addressable Application of Reagents

A sensor platform according to Example 1 (b), with a monodiffractive grating structure modulated over the whole sensor platform, is used together with an excitation module according to Example 2(a)(v). A detection module according to Example 2(b)(i)(I) is selected.

The sensor platform is mounted horizontally, in order to allow for the addition or removal of samples and reagents to respectively to or from individually addressable, open sample compartments. The structure for the sample compartments is formed from a 1 to 3 mm thick, self-adhesive and fluidly sealing plate of blackened poly dimethlysiloxane, into which a multitude of continuously arranged openings (with typical diameters of 1 mm-3 mm) have been inserted. The openings correspond geometrically to the measurement areas or to the segments combined from several measurement areas to be addressed individually with fluid. The PDMS plate structured in this manner, which can be formed from a corresponding master at a high copy number (like the sample compartments described as examples previously) is brought into contact with the surface of the sensor platform and adheres to the sensor platform upon fluidic sealing of the openings against each other. Equal or different samples and reagents are filled into or removed from the sample compartments by a single dispenser or a multi-dispenser in parallel. For avoiding evaporation, especially in the case of highly volatile samples or reagents, the fluid application steps are performed in the presence of a saturated atmosphere of water vapor.

The dispenser is pail of a fluidic system further comprising a commercial auto-sampler (Gilson 231 XL), one or more multi-port valves, and a sample loop. Upon switching the one or more valves and actuation by the pumps, different reagents or samples can be directed to the measurement areas.

(d) Sample and Reagent Application by a Dispenser, Without Additional Sample Compartments

A sensor platform according to Example 1(b) with a monodiffractive grating structure modulated over the whole sensor platform is used together with an excitation module according to Example 2(a)(v). A detection module according to Example 2(b)(i)(I) is selected.

The sensor platform is mounted horizontally in order to allow for addition or removal of samples and reagents respectively to or from individually addressable, open sample compartments. Equal or different samples and reagents are applied, addressed individually, to the measurement areas or segments or removed there from by a single dispenser or multi-dispenser in parallel. For avoiding evaporation, especially in the case of highly volatile samples or reagents, the fluid application steps are performed in the presence of a saturated atmosphere of water vapor.

The dispenser is part of a fluidic system further comprising a commercial auto-sampler (Gilson 231 XL), one or more multi-port valves, and a sample loop. Upon switching the one or more valves and actuation by the pumps, different reagents or samples can be directed to the measurement areas.

### EXAMPLE 4

### Method for the Detection of Luminescence

4(a) Applied Solutions

(1) Hybridization buffer (pH 7.7), consisting of 326 ml phosphate buffer (0.070 M, pH 7), 29.5 g KCl, 0.09 g EDTA×2 H₂O, 2.25 g poly(acrylic acid) 5100 sodium salt, 2.25 g Tween 20, 1.13 g sodium azide, filled up to 4.5 l with destined water and adjusted to pH 7.7 with 1-molar soda lye.

(2) Sample solution (16*c-Cy-5): Cy5-labeled oligomer consisting of 16 base pairs (Cy5-5′-GTTGTGTGGAATTGTG−3′ (10⁻⁹ M) in hybridization buffer 1), complementary to the oligomer immobilized in the measurement areas.

(3) Regeneration solution: 0.22 g sodium chloride, 0.11 g sodium citrate, 2.5 g Tween 20, 142 g formamide, and 0.13 g sodium azide, dissolved in 250 ml deionized water.

4. (b) Method of Measurement

(i) A sensor platform according to Example 1(a) is used together with an excitation module according to Example 2(a)(v), as well as with a detection module according to Example 2(b)(i)(I) and a closed flow cell according to Example 3(a).

The method of measurement consists of the following individual steps, including 5 minutes of washing with hybridization buffer 1) (0.5 ml/min), and recording of the background signal, 5 minutes of suppling the sample solution (1 nM 16*c-Cy-5; 0.5 ml/min), 5 minutes of washing with hybridization buffer, 5 minutes of suppling the regeneration solution (0.5 ml/min), and 5 minutes of washing with hybridization buffer (re-equilibration).

During the measurement process, camera images of the sensor platform with the measurement areas located thereon are recorded in intervals of one minute at the luminescence wavelength.

(ii) A sensor platform according to Example 1(b) is used together with an excitation module according to Example 2(a)(v), as well as with a detection module according to Example 2(b)(i)(1) and a closed flow cell according to Example 3(a).

The method of measurement consists of the following individual steps, including 5 minutes of washing with hybridization buffer 1) (0.5 ml/min), and recording of the background signal, 5 minutes of suppling the sample solution (1 nM 16*c-Cy-5; 0.5 ml/min), 5 minutes of washing with hybridization buffer, 5 minutes of suppling the regeneration solution (0.5 ml/min), and 5 minutes of washing with hybridization buffer (re-equilibration).

During the measurement process, camera images of the sensor platform with the measurement areas located thereon are recorded in intervals of one minute at the luminescence wavelength.

4(c) Results

(i) In the following, results obtained according the method of measurement 4(b)(i) are discussed as an example. At the beginning, the expanded excitation light beam was directed onto the center of the grating structure I, under incoupling conditions, and generated a directly illuminated area of 4 mm length×9 mm width. The lowest row of the 6×6 measurement areas (columns×rows) was not considered in the analysis, as it was located near the border of the flow cell. Therefore, analyte supply did not occur under the same conditions as for the other measurement areas. The following average net luminescence signals, as a difference between the absolute signals and the background signals from these measurement areas, were determined after the hybridization step (Table 1, unit: “counts per second, cps”):

TABLE 1

| | Column | | | | | |
|---|---|---|---|---|---|---|
| | 1 | 2 | 3 | 4 | 5 | 6 |
| Row 1 | 14800 | 19350 | 21100 | 33000 | 34300 | 39000 |
| Row 2 | 15600 | 18410 | 21800 | 34900 | 38010 | 38300 |
| Row 3 | 14600 | 17700 | 19700 | 32600 | 32700 | 41400 |
| Row 4 | 14900 | 20700 | 19700 | 27200 | 36900 | 42100 |
| Row 5 | 13500 | 16300 | 19100 | 23700 | 31000 | 41300 |
| Average | 14680 | 18492 | 20280 | 30280 | 34582 | 40420 |
| Std. Dev. | 5.2 | 9.0 | 5.5 | 15.4 | 8.4 | 4.1 |
| %) | | | | | | |

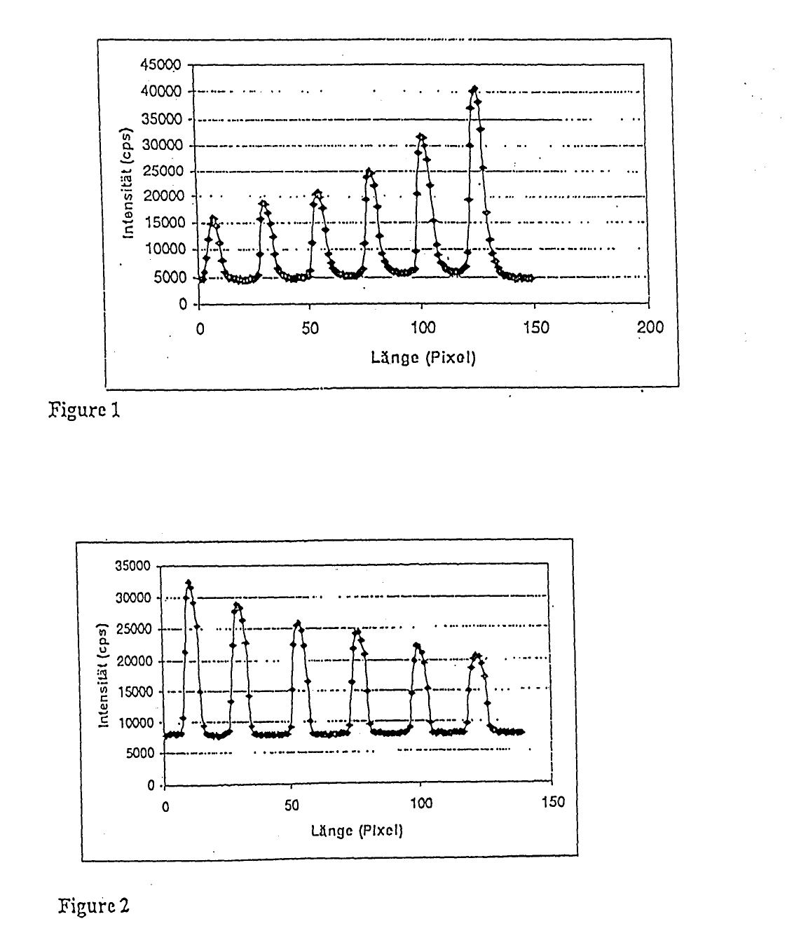

In the case of the sensor platform used in Example 1(a) with a grating depth of 12+/−3 nm, the efficiency of the in- and outcoupling of the excitation light was incomplete, resulting in a positive gradient of the intensity of available excitation light in the direction of the guided mode, with the consequence of an increase of the observed luminescence signals with increasing column numbers in Table 1. As an example, the pattern of the total luminescence signals, i.e., before subtraction of the background signals, along row 5 of the measurement areas is depicted in FIG. 1 for graphic visualization.

In the further course of the method of measurement 4(b)(i), the sensor platform was translated in parallel to its length side without a change of the angle, so far that a part of the excitation light that was incoupled close to the right edge of grating structure I could further propagate in the optically transparent layer (a) in the direction of grating structure II, where it was outcoupled. Upon the passage of the excitation light through the area between both grating structures I and II, the second 6×6 array of measurement areas located between the grating structures, as an example for a segment of measurement areas, was excited. The upper two rows of the array were located at the upper border of the sample compartment. The signals from these measurement areas were not considered in the analysis.

The following average net luminescence signals, as a difference between the absolute signals and the background signals from these measurement areas, were determined after the hybridization step (Table 2, unit: “counts per second, cps”):

TABLE 2

| | Column | | | | | |
|---|---|---|---|---|---|---|
| | 1 | 2 | 3 | 4 | 5 | 6 |
| Row 3 | 27174 | 18900 | 18230 | 17964 | 13080 | 11943 |
| Row 4 | 27900 | 19410 | 19025 | 17950 | 16130 | 14500 |
| Row 5 | 26033 | 21530 | 20667 | 17025 | 15217 | 13000 |
| Row 6 | 24274 | 22290 | 17949 | 16621 | 14265 | 11700 |
| Average | 26345 | 21076 | 18968 | 17390 | 14673 | 12786 |
| Std. Dev. | 6.0 | 5.8 | 6.4 | 3.9 | 8.9 | 10.0 |
| (%) | | | | | | |

The propagation losses in the optically transparent layer (a) between the grating structures I and II, corresponding to a negative gradient of the intensity of available guided excitation light, were relatively high in this example, resulting in a significant decrease of the net luminescence signals with increasing propagation length of the guided excitation light or with increasing column number of the measurement areas, respectively (see Table 2). As an example, the pattern of the total luminescence signals, i.e., before subtraction of the background signals, along row 5 of the measurement areas, in accordance with Table 2, is depicted in FIG. 2 for graphic visualization.

In the further course of this method of measurement, the angle between the sensor platform and its normal was changed from −4°, leading to a mode of guided excitation light propagating to the right in the optically transparent layer (a), referring to the above pictures, to +4°. Thus, the incoupling condition for generation of a mode propagating to the left is satisfied.

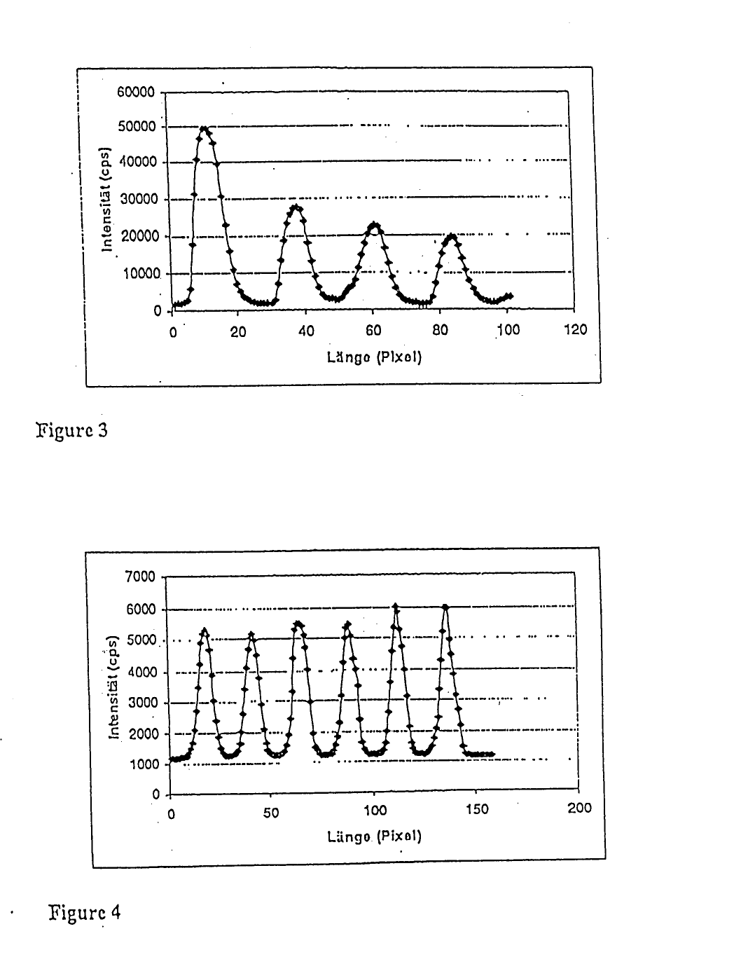

Thus, 4 columns of the 6×6 array of measurement areas on grating structure I could be excited under incoupling conditions. Because of the incomplete efficiency of in- and outcoupling, a gradient of the intensity of available guided excitation light increasing to the left is thus established, as can be seen in the pattern of the total luminescence signals, i.e., before subtraction of the background signals, along row 5 of the measurement areas in FIG. 3, as an example.

(ii) In the following, results of the method of measurement 4(b)(ii) are discussed as further examples. The expanded excitation light beam was directed, under incoupling conditions, onto an allay of measurement areas located on the sensor platform, on which a uniform grating structure was modulated continuously over the whole sensor platform.

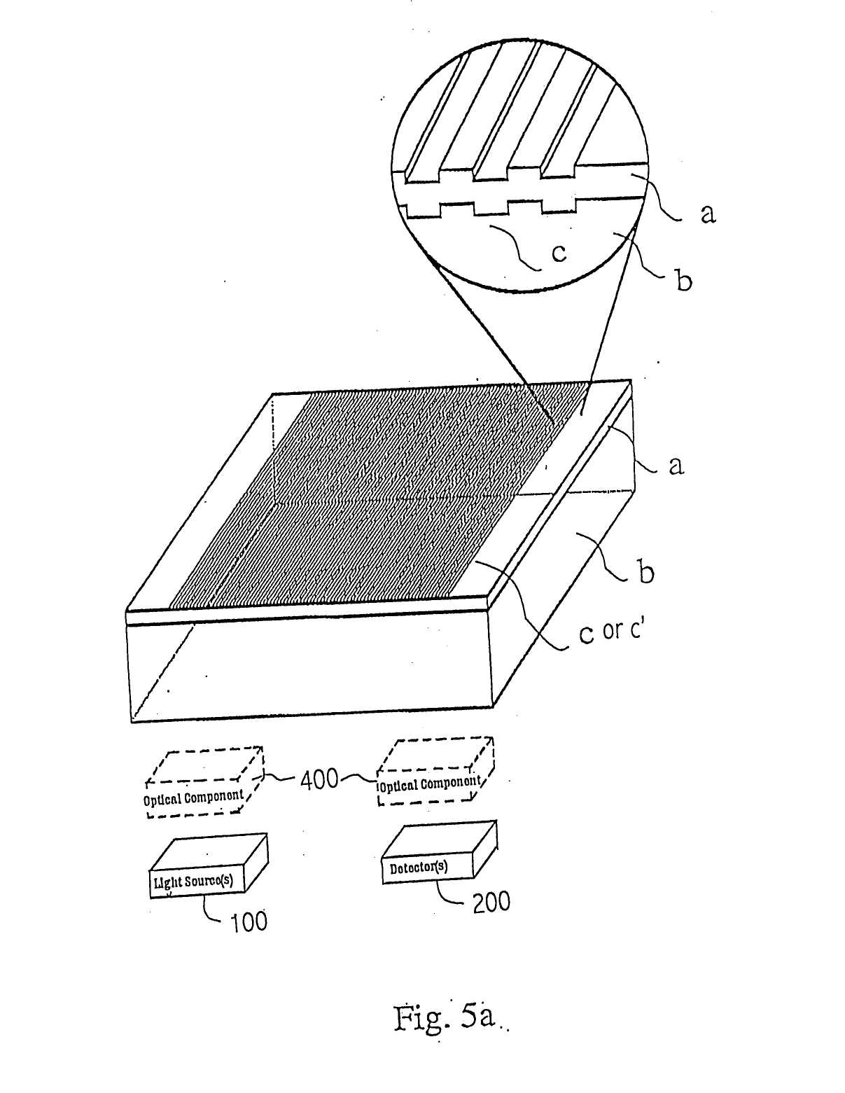

The efficiency of in- and outcoupling was much higher, due to the larger grating depth of 25+/−5 nm, resulting in a very small positive gradient of the intensity of available excitation light in the direction of the guided mode, which effect hardly exceeded the statistical variation of the measurement results. As an example, the pattern of the total luminescence signals, i.e., before subtraction of the background signals, along row 5 of the measurement areas is depicted in FIG. 4 for graphic visualization.

### EXAMPLE 5

(a) Sensor Platforms 101511 (i) A sensor platform with the exterior dimensions of 16 mm width×48 mm length×0.7 mm thickness was used. The substrate material (optically transparent layer (b)) consisted of AF 45 glass (refractive index n=1.52 at 633 nm). The optically transparent layer (a) of Ta₂O₅ on the optically transparent layer (b) was generated upon reactive, magnetic field-enhanced DC-sputtering and had a refractive index of 2.15 at 633 nm (layer thickness 150 nm). The sensor platform additionally comprised two discrete grating structures, each with a period of 360 nm, in an arrangement similar to Example 1(a) (dimensions of 5 mm length×12 mm width and 1 mm length×12 mm width, respectively, with grating depth of 12+/−3 nm). In the method of measurement described below, however, the grating structures were not specifically used for luminescence excitation or luminescence detection. 101521 (ii) A sensor platform with the exterior dimensions of 16 mm width×48 mm length×0.7 mm thickness was used with physical parameters similar to Example 1(b). The substrate material (optically transparent layer (b)) consisted of AF 45 glass (refractive index n=1.52 at 633 nm). A continuous structure of a surface relief grating, with a period of 360 nm and a grating depth of 25+/−5 nm, was generated in the substrate by holographic exposure of the layer (b) covered with a photo resist deposited by spin-coating followed by wet chemical etching, with orientation of the grating lines in parallel to the given width of the sensor platform. The waveguiding, optically transparent layer (a) of Ta₂O₅ on the optically transparent layer (b) was generated by reactive, magnetic field-enhanced DC-sputtering (see DE 4410258), and had a refractive index of 2.15 at 633 nm (layer thickness 150 nm). Under incoupling conditions, excitation light of 633 mn could be coupled into the structure under an angle of about +3°, and incoupling or outcoupling of light with a wavelength of 670 nm (corresponding to the maximum of the fluorescence of Cy5) occurs under an angle of approximately −6°.

As a preparation for the immobilization of the biochemical, biological or synthetic recognition elements, the sensor platforms 5(a) (i) and (ii) were cleaned and silanized with epoxy silane in the liquid phase, (10 ml (2% v/v) 3-glycidyloxypropyltrimethoxy silane and 1 ml (0.2% v/v) N-ethyldiisopropyl amine in 500 ml orto-xylene (7 hours at 70° C.)). Then, solutions of fluorescently labeled 18-mer oligonucleotides (Cy5-5′-CCGTAACCTCATGATATT-3′-NH2, 18*Cy5-NH2) were deposited in two arrays, each comprising 16×8 spots (8 rows×16 columns; 50 pl per spot), with a commercial spotter (Genetic Microsystem 417 arrayer). The concentration of the spotted solutions was, alternating by row, 10⁻⁷ M and 10⁻⁸ M 18*Cy5-NH2, respectively, resulting in fluorophore concentrations in the deposited spots (about 125 μm diameter, with a center-to-center distance of 375 μm) of 100 and 10 fluorophores per μm², respectively.

The spot arrays, each of about 3.2 mm width×5.8 mm length, were arranged in a row on the sensor platform, with a spacing of 3.3 mm, so that in the case of the sensor platform (i), both arrays were located at a distance of several millimeters to the next coupling gratings.

(b) Optical System

The fluorescence intensity from the spot arrays on the sensor platforms (i) and (ii) was measured with a commercial scanner (Genetic Microsystems 418 Array Scanner), upon launching of the excitation light in an arrangement of direct illumination with a convergent excitation light bundle. Thereby, the optical axis of the excitation light bundle was orientated normally to the sensor platform. The excitation light intensity was about 5 mW. The numerical aperture of the objective lens of the laser scanner corresponded to a half opening angle of about 530. The scan speed was according to the value given in the product catalogue (18 mm/min, with a scan width of 22 mm).

For a further comparison, the fluorescence from the measurement areas on the sensor platform (i) (with grating structures I and II) was measured under incoupling conditions, using a parallel excitation light bundle upon incoupling at the right edge of grating structure I (1 mm length×12 mm width; incoupling angle +30). Thereby, an excitation module according to Example 2/excitation module (a)(ii) (excitation beam from a helium neon laser, 0.6 mW, expanded with a cylindrical lens) was used in combination with a detection module according to Example 2(b)(i)(I).

(c) Results

A selection of the measurement results is summarized in Table 3. The signals (net fluorescence signals as the difference between total signals and local background signals), background signals and noise were determined from four partitions, each comprising 10 adjacent spots of equal fluorophore concentration (10 fluorophores per μm²), in the case of the direct illumination applied to sensor platforms (i) and (ii), respectively, from two such partitions in the case of the evanescent excitation, i.e., incoupling of the excitation light to the measurement areas located on the unstructured part of sensor platform (i).

With the configuration of direct illumination, significantly higher fluorescence signals are observed with sensor platform (ii), with measurement areas on a monodiffractive grating modulated over the whole platform, than with sensor platform (i) without a grating structure in the region of the measurement areas. Under the applied experimental conditions, an incoupling of excitation light into the optically transparent, waveguiding layer (a) can be excluded strictly in the case of the sensor platform (i) and be neglected to a large extent in the case of the sensor platform (ii), since only a very small part of the excitation light, regarding the strongly convergent excitation light path, hitting the grating structure under such an angle, could have such an incoupling occur. The significant increase of the observed fluorescence intensity has to be attributed to a significant portion of the fluorescence from fluorophores located in the near field of the optically transparent layer (a), non-evanescently excited, that is coupled into this layer. After a very short propagation length, which is dependent on the depth of the grating structure, however, it is outcoupled again by the continuously modulated grating structure. The outcoupling occurs under an angle of about −6°, due to the given parameters of the sensor platform, and the outcoupled portion is also collected by the detector due to the high numerical aperture of the objective. A small part of the observed luminescence increase may additionally be attributed to a small portion of incoupled excitation light. The high outcoupling efficiency is demonstrated by the observation that no significant differences of the background signals are observed, resulting in an efficient prevention, according to the invention, of a cross-talk of back-coupled fluorescence light between adjacent measurement areas.

In the case of the sensor platform (i), having the same parameters, a similar portion of luminescence light will incouple into layer (a). In this case, however, incoupled fluorescence light can only be outcoupled by the grating structures located outside of the field of view of the detector, or exit at the lateral edges of the sensor platform.

The measurements with the tenfold higher fluorophore concentration led to about tenfold higher fluorescence signals and signal-to-noise ratios for both sensor platforms. The ratio of the net signal to the noise can still be improved by multiple scanning, associated with a correspondingly extended measurement time (in the example from 1 minute to 10 minutes for ten-fold scanning), in this example, by approximately a factor 3.

The comparative measurement with the sensor platform (i) under incoupling conditions demonstrates that the sensitivity can be further increased significantly, with much weaker excitation light, by this an arrangement according to the invention, namely, by a factor of 5 to 12 under these conditions, dependent on the exposure time. For this method, additionally, significantly shorter measurement times are required, as it is obvious from the conditions according to the example.

TABLE 3

| | Direct excitation: | | | | |
|---|---|---|---|---|---|
| | Scanner 418 | | | | |
| | Platform | Platform | Evanescent excitation, platform (i) | | |
| | (i) | (ii) | 1 sec | 3 sec | 10 sec |
| Net | 196 +/− | 905 +/− | 541 +/− | 1511 +/− | 4097 +/− |
| signal | 34 | 228 | 21 | 83 | 263 |
| Back- | 253 +/− | 237 +/− | 86 +/− | 241 +/− | 683 +/− |
| ground | 8 | 6 | 5 | 15 | 47 |
| Noise | 144 +/− | 164 +/ − | 19.8 +/ − | 30.5 +/− | 62 +/− |
| | 4 | 2 | 0.4 | 2.7 | 12 |
| Signal / | 1.4 +/− | 5.5 +/− | 27.3 +/− | 49.6 +/− | 67 +/− |
| noise | 0.3 | 1.3 | 0.5 | 1.6 | 8 |

What is claimed is:

1. A sensor platform for a simultaneous determination of at least one luminescence from a plurality of measurement areas, said sensor platform comprising:
a plurality of laterally separated measurement areas, wherein a density of said plurality of laterally separated measurement areas is at least 16 measurement areas per square centimeter;
an optical film waveguide comprising a first optically transparent layer, a second optically transparent layer having a lower refractive index than said first optically transparent layer, said first optically transparent layer being on said second optically transparent layer, and a grating structure being operable to incouple excitation light to said plurality of laterally separated measurement areas, wherein said plurality of laterally separated measurement areas are located on said first optically transparent layer, said grating structure is continuously modulated in an area of said plurality of laterally separated measurement areas, and said grating structure is operable to prevent a cross-talk of luminescence generated in any one measurement area of said plurality of laterally separated measurement areas and coupled back into said first optically transparent layer to any other measurement area of said plurality of laterally separated measurement areas; and
a plurality of recognition elements immobilized in said plurality of laterally separated measurement areas, said plurality of recognition elements being operable to assist in a qualitative or quantitative determination of at least one analyte in a sample in contact with said plurality of laterally separated measurement areas.

2. A sensor platform according to claim 1, wherein said plurality of laterally separated measurement areas are split into at least two laterally separated segments, each of said laterally separated segments comprising at least two of said plurality of laterally separated measurement areas.

3. A sensor platform according to claim 1, wherein said grating structure is a superposition of a plurality of grating structures of different periodicities for the incoupling of excitation light of different wavelengths.

4. A sensor platform according to claim 1, further comprising a third optically transparent layer in contact with said first optically transparent layer, wherein said third optically transparent layer has a lower refractive index than said first optically transparent layer and said third optically transparent layer has a thickness of 5 nm-10,000 nm and is located between said first optically transparent layer and said second optically transparent layer.

5. A sensor platform according to claim 1, further comprising an adhesion-promoting layer with a thickness of less than 200 nm deposited on said first optically transparent layer, said adhesion-promoting layer operable to immobilize one of biological elements, biochemical elements and synthetic recognition elements, wherein said adhesion-promoting layer comprises chemical compounds from a group consisting of silanes, epoxides, and self-organized functionalized monolayers.

6. A sensor platform according to claim 1, wherein said plurality of laterally separated measurement areas are generated by laterally selective deposition of at least one of biological elements, biochemical elements and synthetic recognition elements on said sensor platform, by one of jet spotting, mechanical spotting, micro contact printing, and fluidic contacting said plurality of laterally separated measurement areas with said at least one of biological elements, biochemical elements and synthetic recognition elements supplied in parallel or by crossed micro channels, upon application of one of pressure differences, electric potentials and electromagnetic potentials.

7. A sensor platform according to claim 6, wherein said at least one of biological elements, biochemical elements and synthetic recognition elements, components of a group consisting of nucleic acids and nucleic acid analogues, antibodies, aptamers, membrane-bound and isolated receptors, ligands of the membrane-bound and isolated receptors, antigens for antibodies, histidine-tag components, and molecular imprints hosted in cavities generated by chemical synthesis, are deposited as whole cells or cell fragments.

8. A sensor platform according to claim 6, further comprising compounds, which are chemically neutral towards the at least one analyte, deposited between said plurality of laterally separated measurement areas in order to minimize nonspecific binding or adsorption.

9. A sensor platform according to claim 1, wherein said plurality of laterally separated measurement areas is up to 100,000 laterally separated measurement areas provided in a two-dimensional arrangement and a single laterally separated measurement area has an area of 0.001 mm²-6 mm².

10. A sensor platform according to claim 1, wherein said grating structure is one of a diffractive grating with a uniform period and a multidiffractive grating.

11. A sensor platform according to claim 1, wherein said grating structure has a laterally varying periodicity either in parallel or perpendicular to a direction of propagation of the incoupled excitation light in said first optically transparent layer.

12. A sensor platform according to claim 1, wherein said second optically transparent layer comprises one of quartz, glass or transparent thermoplastic.

13. A sensor platform according to claim 1, wherein said first optically transparent layer has a refractive index that is higher than 2.

14. A sensor platform according to claim 1, wherein said first optically transparent layer comprises one of TiO₂, ZnO, Nb₂O₅, Ta₂O₅, HfO₂, or ZrO₂.

15. A sensor platform according to claim 1, wherein said first optically transparent layer has a thickness of between 40 and 300 nm.

16. A sensor platform according to claim 1, wherein said grating structure has a period of 200 nm-1,000 nm and a modulation depth of 3 nm-100 nm.

17. A sensor platform according to claim 1, wherein, by incomplete incoupling and outcoupling of at least one of the excitation light and backcoupled luminescence light, a positive gradient of at least one of intensity of guided excitation light and generated luminescence light within at least one measurement area of said plurality of laterally separated measurement areas and across several measurement areas of said plurality of laterally separated measurement areas, that can be controlled by a depth of said grating structure, is generated in parallel to a direction of propagation of the incoupled excitation light.

18. A sensor platform according to claim 17, wherein said grating structure has a laterally varying grating depth in parallel with the direction of propagation of the incoupled excitation light.

19. A sensor platform according to claim 1, wherein at least one of a negative gradient of intensity of guided excitation light and generated luminescence light within at least one measurement area of said plurality of laterally separated measurement areas and across several measurement areas of said plurality of laterally separated measurement areas, that can be controlled by an extent of propagation losses in said first optically transparent layer, is generated in parallel to a direction of propagation of the incoupled excitation light.

20. A sensor platform according to claim 16, wherein a ratio of the modulation depth to a thickness of said first optically transparent layer is equal or smaller than 0.2.

21. A sensor platform according to claim 1, wherein said grating structure is one of a relief grating with a rectangular, triangular or semi-circular profile and a phase or volume grating with a periodic modulation of a refractive index in said first optically transparent layer which is essentially planar.

22. A sensor platform according to claim 1, further comprising one of optically recognizable marks and mechanically recognizable marks operable to simplify adjustments in an optical system, or for connection to sample compartments as part of an analytical system.

23. An optical system for the determination of one or more luminescences, said optical system comprising:
at least one excitation light source operable to emit excitation light;
a sensor platform comprising:
a plurality of laterally separated measurement areas, wherein a density of said plurality of laterally separated measurement areas is at least 16 measurement areas per square centimeter;
an optical film waveguide comprising a first optically transparent layer, a second optically transparent layer having a lower refractive index than said first optically transparent layer, said first optically transparent layer being on said second optically transparent layer, and a grating structure being operable to incouple the excitation light to said plurality of laterally separated measurement areas, wherein said plurality of laterally separated measurement areas are located on said first optically transparent layer, said grating structure is continuously modulated in an area of said plurality of laterally separated measurement areas, and said grating structure is operable to prevent a cross-talk of luminescence generated in any one measurement area of said plurality of laterally separated measurement areas and coupled back into said first optically transparent layer to any other measurement area of said plurality of laterally separated measurement areas; and
a plurality of recognition elements immobilized in said plurality of laterally separated measurement areas, said plurality of recognition elements being operable to assist in a qualitative or quantitative determination of at least one analyte in a sample in contact with said plurality of laterally separated measurement areas; and
at least one detector operable to collect light emanating from one or more of said plurality of laterally separated measurement areas on said sensor platform.

24. An optical system according to claim 23, wherein said at least one excitation light source launches the excitation light to said plurality of laterally separated measurement areas in an arrangement of direct or transmission illumination.

25. An optical system according to claim 23, wherein said at least one detector also collects luminescence light outcoupled by said grating structure.

26. An optical system according to claim 23, wherein the excitation light emitted from said at least one excitation light source is coherent and is launched to said plurality of laterally separated measurement areas at a resonance angle for coupling into said first optically transparent layer.

27. An optical system according to claim 23, wherein said at least one excitation light source is a plurality of coherent light sources of one of similar and different emission wavelengths.

28. An optical system according to claim 27, wherein said grating structure is a superposition of a plurality of grating structures of different periodicities for the incoupling of excitation light of different wavelengths, and wherein said plurality of coherent light sources launch the excitation light either simultaneously or sequentially from different directions on said grating structure.

29. An optical system according to claim 23, wherein said at least one detector is a laterally resolving detector from a group consisting of CCD cameras, CCD chips, photodiode arrays, avalanche diode allays, multichannel plates and multichannel photomultipliers.

30. An optical system according to claim 23, further comprising at least one optical component being located between at least one of said at least one excitation light source and said sensor platform and said sensor platform and said at least one detector, said at least one optical component comprising at least one of:
a lense or a lens system operable to shape at least one of the excitation light and the one or more luminescences;
a planar mirror or a curved mirror for deviation of at least one of the excitation light and the one or more luminescences;
a prism for deviation of at least one of the excitation light and the one or more luminescences;
a dichroic mirror for the spectrally selective deviation of parts of at least one of the excitation light and the one or more luminescences;
a neutral density filter for regulation of light intensity of at least one of the excitation light and the one or more luminescences;
an optical filter or a monochromator for spectrally selective transmission of parts of at least one of the excitation light and the one or more luminescences; and
a polarization selective element for selection of discrete polarization directions of at least one of the excitation light and the one or more luminescences.

31. An optical system according to claim 23, wherein said at least one excitation light source launches the excitation light in pulses with a duration of 1 fsec to 10 min and emission light from said plurality of laterally separated measurement areas is measured time-resolved.

32. An optical system according to claim 23, wherein said at least one detector measures light signals from at least one of the excitation light at a location of said at least one excitation light source, the excitation light after expansion, the excitation light after being multiplexed into individual beams, scattered excitation light from a location of one or more measurement areas of said plurality of laterally separated measurement areas, and the excitation light outcoupled by said grating structure beside said plurality of measurement areas for referencing purposes as a reference signal.

33. An optical system according to claim 32, wherein said one or more of said plurality of measurement areas for determination of the emission light and for the determination of the reference signal are the same.

34. An optical system according to claim 23, wherein said at least one excitation light source and said at least one detector respectively launch the excitation light and detect the emission light from said plurality of laterally separated measurement areas sequentially for one or more measurement areas of said plurality of laterally separated measurement areas.

35. An optical system according to claim 34, wherein said sensor platform is operable to be moved between the sequential excitation and detection.

36. An analytical system for the determination of one or more analytes in at least one sample by luminescence detection, said analytical system comprising:
at least one excitation light source operable to emit excitation light;
a sensor platform comprising:
a plurality of laterally separated measurement areas, wherein a density of said plurality of laterally separated measurement areas is at least 16 measurement areas per square centimeter;
an optical film waveguide comprising a first optically transparent layer, a second optically transparent layer having a lower refractive index than said first optically transparent layer, said first optically transparent layer being on said second optically transparent layer, and a grating structure being operable to incouple the excitation light to said plurality of laterally separated measurement areas, wherein said plurality of laterally separated measurement areas are located on said first optically transparent layer, said grating structure is continuously modulated in an area of said plurality of laterally separated measurement areas, and said grating structure is operable to prevent a cross-talk of luminescence generated in said plurality of laterally separated measurement areas, and coupled back into said first optically transparent layer to any other measurement area of said plurality of laterally separated measurement areas; and
at least one recognition element immobilized in said plurality of laterally separated measurement areas, said at least one recognition element being operable to assist in a qualitative or quantitative determination of the one or more analytes in the at least one sample in contact with said plurality of laterally separated measurement areas;
at least one detector operable to collect light emanating from said plurality of laterally separated measurement areas on said sensor platform; and
supply means for supplying the at least one sample in contact with said plurality of laterally separated measurement areas on said sensor platform.

37. An analytical system according to claim 36, further comprising at least one sample compartment which is at least in the area of at least one laterally separated measurement area of said plurality of laterally separated measurement areas, wherein said at least one sample compartment has a volume of 0.1 nl-100 μl.

38. An analytical system according to claim 37, wherein said at least one sample compartment has at least one opening for supplying and removing samples at a side opposite to said first optically transparent layer, said at least one sample compartment being otherwise closed, and wherein the supplying and removing of the samples is performed in a closed flow through system.

39. An analytical system according to claim 37, wherein said at least one sample compartment has an opening for supplying or removing samples or other reagents at a side opposite to said first optically transparent layer.

40. An analytical system according to claim 37, wherein said at least one sample compartment is adapted to accept reagents such that the reagents can be wetted during an assay for the determination of the one or more analytes and in contact with said at least one laterally separated measurement area.

41. A method comprising simultaneously determining by luminescence detection, at least one analyte in one or more samples with a sensor platform comprising
a plurality of laterally separated measurement areas, wherein a density of the plurality of laterally separated measurement areas is at least 16 measurement areas per square centimeter,
an optical film waveguide comprising a first optically transparent layer, a second optically transparent layer having a lower refractive index than the first optically transparent layer, the first optically transparent layer being on the second optically transparent layer, and a grating structure being operable to incouple excitation light to the plurality of laterally separated measurement areas, wherein the plurality of laterally separated measurement areas are located on the first optically transparent layer, the grating structure is continuously modulated in an area of the plurality of laterally separated measurement areas, and the grating structure is operable to prevent a cross-talk of luminescence generated in any one measurement area of the plurality of laterally separated measurement areas and coupled back into the first optically transparent layer to any other measurement area of the plurality of laterally separated measurement areas, and
a plurality of recognition elements immobilized in the plurality of laterally separated measurement areas, the plurality of recognition elements being operable to assist in a qualitative or quantitative determination of the at least one analyte in the one or more samples in contact with the plurality of laterally separated measurement areas to determine the at least one analyte in the one or more samples.

42. A method according to claim 41, wherein said grating structure couples in the excitation light for the plurality of laterally separated measurement areas.

43. A method according to claim 41, further comprising simultaneously measuring at least one of isotropically emitted luminescence or luminescence that is coupled back into the first optically transparent layer and outcoupled by the grating structure.

44. A method comprising determining one or more analytes by luminescence detection with a sensor platform comprising
a plurality of laterally separated measurement areas, wherein a density of the plurality of laterally separated measurement areas is at least 16 measurement areas per square centimeter,
an optical film waveguide comprising a first optically transparent layer, a second optically transparent layer having a lower refractive index than the first optically transparent layer, the first optically transparent layer being on the second optically transparent layer, and a grating structure being operable to incouple excitation light to the plurality of laterally separated measurement areas, wherein the plurality of laterally separated measurement areas are located on the first optically transparent layer, the grating structure is continuously modulated in an area of the plurality of laterally separated measurement areas, and the grating structure is operable to prevent a cross-talk of luminescence generated in any one measurement area of the plurality of laterally separated measurement areas and coupled back into the first optically transparent layer to any other measurement area of the plurality of laterally separated measurement areas, and
a plurality of recognition elements immobilized in the plurality of laterally separated measurement areas, the plurality of recognition elements being operable to assist in a qualitative or quantitative determination of at least one analyte in a sample in contact with the plurality of laterally separated measurement areas,
wherein, by incomplete incoupling and outcoupling of at least one of the excitation light and backcoupled luminescence light, a positive gradient of at least one of an intensity of guided excitation light and an intensity of the generated luminescence within at least one measurement area of the plurality of laterally separated measurement areas and across several measurement areas of the plurality of laterally separated measurement areas, that can be controlled by a depth of the grating structure, is generated in parallel to a direction of propagation of the incoupled excitation light, and
wherein at least one of a dynamic range for signal measurement and a quantitative analyte determination can be increased or limited by a controllable gradient of at least one of the guided excitation light and excited luminescence light in parallel to the direction of propagation of the incoupled excitation light, within at least one of a single measurement area of the plurality of laterally separated measurement areas and across several measurement areas of the plurality of laterally separated measurement areas.

45. A method according to claim 41, wherein one of a luminescent dye and a nanoparticle is used as a luminescence label for generation of the luminescence, which can be excited and emits at a wavelength between 300 nm and 1100 nm.

46. A method according to claim 45, wherein the luminescence label is bound to one of the one or more analytes, an analyte analogue in a competitive assay, and one of binding partners of the plurality of recognition elements or the plurality of recognition elements in a multi-step assay.

47. A method according to claim 45, wherein at least one additional luminescence label is used.

48. A method according to claim 47, wherein the second or more luminescence labels can be excited at the same wavelength as the first luminescence label, but emit at other wavelengths.

49. A method according to claim 47, wherein the luminescence label and the at least one additional luminescence label are luminescent dyes that have excitation and emission spectra that do not or only partially overlap.

50. A method according to claim 47, wherein the luminescence label and the at least one additional luminescence label are luminescent dyes and charge transfer or optical energy transfer from a first luminescent dye acting as a donor to a second luminescent dye acting as an acceptor is used for the detection of the one or more analytes.

51. A method according to claim 41, further comprising determining changes of an effective refractive index on the plurality of laterally separated measurement areas in addition to determining one or more analytes by luminescence.

52. A method according to claim 41, wherein at least one of said determining the one or more analytes by luminescence and determination of light signals at excitation wavelengths are performed as polarization-selective, and wherein one or more luminescences are measured at a polarization that is different from a polarization of the excitation light.

53. A method comprising simultaneously or sequentially determining one or more analytes from a group consisting of antibodies or antigens, receptors or ligands, chelators or histidine-tag components, oligonucleotides, DNA or RNA strands, DNA or RNA analogues, enzymes, enzyme cofactors or inhibitors, lectins and carbohydrates in one or more samples with a sensor platform comprising
a plurality of laterally separated measurement areas, wherein a density of the plurality of laterally separated measurement areas is at least 16 measurement areas per square centimeter,
an optical film waveguide comprising a first optically transparent layer, a second optically transparent layer having a lower refractive index than the first optically transparent layer, the first optically transparent layer being on the second optically transparent layer, and a grating structure being operable to incouple excitation light to the plurality of laterally separated measurement areas, wherein the plurality of laterally separated measurement areas are located on the first optically transparent layer, the grating structure is continuously modulated in an area of the plurality of laterally separated measurement areas, and the grating structure is operable to prevent a cross-talk of luminescence generated in any one measurement area of the plurality of laterally separated measurement areas and coupled back into the first optically transparent layer to any other measurement area of the plurality of laterally separated measurement areas, and
a plurality of recognition elements immobilized in the plurality of laterally separated measurement areas, the plurality of recognition elements being operable to assist in a qualitative or quantitative determination of the one or more analytes in the one or more samples in contact with the plurality of laterally separated measurement areas to determine the one or more analytes in the one or more samples.

54. A method according to claim 41, wherein the one or more samples to be examined are naturally occurring body fluids from a group consisting of blood, serum, plasma, lymph, urine, and egg yolk, optically turbid liquids, surface water, soil extracts, plant extracts, bio- or process broths, or a substance taken from biological tissue.

55. A method comprising determining one of chemical, biochemical and biological analytes with a sensor platform comprising
a plurality of laterally separated measurement areas, wherein a density of the plurality of laterally separated measurement areas is at least 16 measurement areas per square centimeter,
an optical film waveguide comprising a first optically transparent layer, a second optically transparent layer having a lower refractive index than the first optically transparent layer, the first optically transparent layer being on the second optically transparent layer, and a grating structure being operable to incouple excitation light to the plurality of laterally separated measurement areas, wherein the plurality of laterally separated measurement areas are located on the first optically transparent layer, the grating structure is continuously modulated in an area of the plurality of laterally separated measurement areas, and the grating structure is operable to prevent a cross-talk of luminescence generated in any one measurement area of the plurality of laterally separated measurement areas and coupled back into the first optically transparent layer to any other measurement area of the plurality of laterally separated measurement areas, and
a plurality of recognition elements immobilized in the plurality of laterally separated measurement areas, the plurality of recognition elements being operable to assist in a qualitative or quantitative determination of at least one analyte in one or more samples in contact with the plurality of laterally separated measurement areas to determine the at least one analyte in the one or more samples.

56. A sensor platform for a simultaneous determination of at least one luminescence from a plurality of measurement areas, said sensor platform comprising:
a plurality of laterally separated measurement areas, wherein a density of said plurality of laterally separated measurement areas is at least 16 measurement areas per square centimeter;
an optical film waveguide comprising a first optically transparent layer, a second optically transparent layer having a lower refractive index than said first optically transparent layer, said first optically transparent layer being on said second optically transparent layer, and a grating structure continuously modulated in an area of said plurality of laterally separated measurement areas, wherein said plurality of laterally separated measurement areas are located on said first optically transparent layer, and said grating structure is operable to prevent a cross-talk of luminescence generated in any one measurement area of said plurality of laterally separated measurement areas and coupled back into said first optically transparent layer to any other measurement area of said plurality of laterally separated measurement areas; and
a plurality of recognition elements immobilized in said plurality of laterally separated measurement areas, said plurality of recognition elements being operable to assist in a qualitative or quantitative determination of at least one analyte in a sample in contact with said plurality of laterally separated measurement areas.

57. A sensor platform according to claim 56, wherein said plurality of laterally separated measurement areas are split into at least two laterally separated segments, each of said laterally separated segments comprising at least two of said plurality of laterally separated measurement areas.

58. An optical system for the determination of one or more luminescences, said optical system comprising:
at least one excitation light source operable to emit excitation light;
a sensor platform comprising:
a plurality of laterally separated measurement areas, wherein a density of said plurality of laterally separated measurement areas is at least 16 measurement areas per square centimeter;
an optical film waveguide comprising a first optically transparent layer, a second optically transparent layer having a lower refractive index than said first optically transparent layer, said first optically transparent layer being on said second optically transparent layer, and a grating structure continuously modulated in an area of said plurality of laterally separated measurement areas, wherein said plurality of laterally separated measurement areas are located on said first optically transparent layer, and said grating structure is operable to prevent a cross-talk of luminescence generated in any one measurement area of said plurality of laterally separated measurement areas and coupled back into said first optically transparent layer to any other measurement area; and
a plurality of recognition elements immobilized in said plurality of laterally separated measurement areas, said plurality of recognition elements being operable to assist in a qualitative or quantitative determination of at least one analyte in a sample in contact with said plurality of laterally separated measurement areas; and
at least one detector operable to collect light emanating from one or more of said plurality of laterally separated measurement areas on said sensor platform.

59. An analytical system for the determination of one or more analytes in at least one sample by luminescence detection, said analytical system comprising:
at least one excitation light source operable to emit excitation light;
a sensor platform comprising:
a plurality of laterally separated measurement area, wherein a density of said plurality of laterally separated measurement area is at least 16 measurement areas per square centimeter;
an optical film waveguide comprising a first optically transparent layer, a second optically transparent layer having a lower refractive index than said first optically transparent layer, said first optically transparent layer being on said second optically transparent layer, and a grating structure continuously modulated in an area of said plurality of laterally separated measurement areas, wherein said plurality of laterally separated measurement areas are located on said first optically transparent layer, and said grating structure is operable to prevent a cross-talk of luminescence generated in said plurality of laterally separated measurement areas and coupled back into said first optically transparent layer to any other measurement area of said plurality of laterally separated measurement areas; and
at least one recognition element immobilized in said plurality of laterally separated measurement areas, said at least one recognition element being operable to assist in a qualitative or quantitative determination of the one or more analytes in the at least one sample in contact with said plurality of laterally separated measurement areas;
at least one detector operable to collect light emanating from said plurality of laterally separated measurement areas on said sensor platform; and
supply means for supplying the at least one sample in contact with said plurality of laterally separated measurement areas on said sensor platform.

60. A method comprising simultaneously determining by luminescence detection, at least one analyte in one or more samples with a sensor platform comprising
a plurality of laterally separated measurement areas, wherein a density of the plurality of laterally separated measurement areas is at least 16 measurement areas per square centimeter,
an optical film waveguide comprising a first optically transparent layer, a second optically transparent layer having a lower refractive index than the first optically transparent layer, the first optically transparent layer being on the second optically transparent layer, and a grating structure continuously modulated in an area of the plurality of laterally separated measurement areas, wherein the plurality of laterally separated measurement areas are located on the first optically transparent layer, and the grating structure is operable to prevent a cross-talk of luminescence generated in any one measurement area of the plurality of laterally separated measurement areas and coupled back into the first optically transparent layer to any other measurement area of the plurality of laterally separated measurement areas, and
a plurality of recognition elements immobilized in the plurality of laterally separated measurement areas, the plurality of recognition elements being operable to assist in a qualitative or quantitative determination of the at least one analyte in the one or more samples in contact with the plurality of laterally separated measurement areas to determine the at least one analyte in the one or more samples.

61. A method comprising simultaneously or sequentially determining one or more a analytes from a group consisting of antibodies or antigens, receptors or ligands, chelators or histidine-tag components, oligonucleotides, DNA or RNA strands, DNA or RNA analogues, enzymes, enzyme cofactors or inhibitors, lectins and carbohydrates in one or more samples with a sensor platform comprising
a plurality of laterally separated measurement areas, wherein a density of the plurality of laterally separated measurement areas is at least 16 measurement areas per square centimeter,
an optical film waveguide comprising a first optically transparent layer, a second optically transparent layer having a lower refractive index than the first optically transparent layer, the first optically transparent layer being on the second optically transparent layer, and a grating structure continuously modulated in an area of the plurality of laterally separated measurement areas, wherein the plurality of laterally separated measurement areas are located on the first optically transparent layer, and the grating structure is operable to prevent a cross-talk of luminescence generated in any one measurement area of the plurality of laterally separated measurement areas, and coupled back into the first optically transparent layer to any other measurement area of the plurality of laterally separated measurement areas, and
a plurality of recognition elements immobilized in the plurality of laterally separated measurement areas, the plurality of recognition elements being operable to assist in a qualitative or quantitative determination of the one or more analytes in the one or more samples in contact with the plurality of laterally separated measurement areas to determine the one or more analytes in the one or more samples.

62. A method comprising determining one of chemical, biochemical and biological analytes with a sensor platform comprising
a plurality of laterally separated measurement areas, wherein a density of the plurality of laterally separated measurement areas is at least 16 measurement areas per square centimeter,
an optical film waveguide comprising a first optically transparent layer, a second optically transparent layer having a lower refractive index than the first optically transparent layer, the first optically transparent layer being on the second optically transparent layer, and a grating structure continuously modulated in an area of the plurality of laterally separated measurement areas, wherein the plurality of laterally separated measurement areas are located on the first optically transparent layer, and the grating structure is operable to prevent a cross-talk of luminescence generated in any one measurement area of the plurality of laterally separated measurement areas and coupled back into the first optically transparent layer to any other measurement area of the plurality of laterally separated measurement areas, and
a plurality of recognition elements immobilized in the plurality of laterally separated measurement areas, the plurality of recognition elements being operable to assist in a qualitative or quantitative determination of at least one analyte in one or more samples in contact with the plurality of laterally separated measurement areas to determine the at least one analyte in the one or more samples.
